(19) United States
(12) Patent Application Publication
(10) Pub. No.: US 2025/0133565 A1
(43) Pub. Date: Apr. 24, 2025

(54) COORDINATED SCHEDULING FOR REPEATERS

(71) Applicant: MaxLinear, Inc., Carlsbad, CA (US)

(72) Inventors: Iñaki Val Beitia, Vitoria (ES); Sigurd Schelstraete, Menlo Park, CA (US); Marcos Martínez Vázquez, Barcelona (ES)

(73) Assignee: MaxLinear, Inc., Carlsbad, CA (US)

(21) Appl. No.: 18/924,913

(22) Filed: Oct. 23, 2024

Related U.S. Application Data
(60) Provisional application No. 63/592,544, filed on Oct. 23, 2023.

(51) Int. Cl. H04W 72/1273; H04W 56/00

(52) U.S. Cl. CPC H04W 72/1273; H04W 56/001

(57) ABSTRACT

Technology disclosed herein may include an access point (AP) which may include a processing device. The processing device may determine, at the access point, an assigned time for the access point and a wireless device; receive, at the access point, a transmission opportunity (TXOP); identify, at the access point, scheduling information for the TXOP, wherein the TXOP is partitioned into a plurality of TXOP partitions comprising first TXOP partitions associated with the access point and second TXOP partitions associated with the wireless device; and provide, from the access point to the wireless device, scheduling information for the TXOP.

### RELATED APPLICATION

This application claims the benefit of U.S. Provisional Application No. 63/592,544, filed Oct. 23, 2023, the disclosure of which is incorporated herein by reference in its entirety.

The examples discussed in the present disclosure are related to coordinated scheduling for multiple access point network topologies.

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as 802.11a, 802.11b, 801.11g, 802.11n (Wi-Fi® 4), 802.11ac (Wi-Fi® 5), 802.11ax (Wi-Fi® 6), and so forth.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

An access point (AP) may include a processing device. The processing device may determine, at the access point, an assigned time for the access point and a wireless device; receive, at the access point, a transmission opportunity (TXOP); and identify, at the access point, scheduling information for the TXOP in which the TXOP is partitioned into a plurality of TXOP partitions comprising first TXOP partitions associated with the access point and second TXOP partitions associated with the wireless device; and provide, from the access point to the wireless device, scheduling information for the TXOP.

A method for maintaining a latency between a first network segment and a second network segment may include: synchronizing a timing for an access point and a first wireless device; determining transmission opportunity (TXOP) scheduling for the access point and the first wireless device; transmitting data from the access point to the first wireless device; and transmitting the data from the first wireless device to a second wireless device.

A repeater may include a processing device. The processing device may synchronize, at the repeater, a timing for the repeater and an access point; receive, at the access point, scheduling information for a transmit opportunity (TXOP); receive, at the repeater, data from the access point; and transmit, from the repeater to a station (STA), the data.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates a block diagram of a scheduled sequence between an access point (AP) and a wireless device.

FIG. 2 illustrates a block diagram of trigger-based downlink and uplink transactions.

FIG. 3 illustrates wireless communication through a repeater device.

FIG. 4 illustrates coordinated time division multiple access (TDMA) between an AP and a repeater.

FIG. 5 illustrates coordinated scheduling between an AP, a repeater, and a station (STA).

FIG. 6 illustrates communication between a plurality of access points.

FIG. 7A illustrates communication between an access point (AP) basic service set 1 (BSS1), an AP basic service set 2 (BSS2), and other wireless devices.

FIG. 7B illustrates communication between an AP BSS1, an AP BSS2, and other wireless devices.

FIG. 8 illustrates communication between a plurality of access points and a plurality of stations.

FIG. 9 illustrates a block diagram of an example system configured to perform coordinated scheduling.

FIG. 10 illustrates a process flow of an example method of coordinated scheduling.

FIG. 11 illustrates a process flow of an example method of coordinated scheduling.

FIG. 12 illustrates a process flow of an example method of coordinated scheduling.

FIG. 13 illustrates an example computing system that may be used for coordinated scheduling, all arranged in accordance with some examples of the present disclosure.

FIG. 14 illustrates an overlapping basic service set simulation setup.

FIG. 15 illustrates a repeater simulation setup.

FIG. 16 illustrates communication between an AP BSS1 and an AP BSS2.

FIG. 17A illustrates overlapping basic service set (OBSS) network results.

FIG. 17B illustrates OBSS network results.

FIG. 18A illustrates OBSS gaming results.

FIG. 18B illustrates OBSS gaming results.

FIG. 19A illustrates OBSS video conference results.

FIG. 19B illustrates OBSS video conference results.

FIG. 20A illustrates OBSS video streaming results.

FIG. 20B illustrates OBSS video streaming results.

FIG. 21 illustrates repeater/mesh simulation results.

FIG. 22 illustrates repeater/mesh gaming results.

FIG. 23 illustrates repeater/mesh video conference results.

FIG. 24 illustrates repeater/mesh video streaming results.

FIG. 25 illustrates repeater/mesh simulation results.

FIG. 26 illustrates repeater/mesh gaming results.

FIG. 27 illustrates repeater/mesh video conference results.

FIG. 28 illustrates repeater/mesh video streaming results.

FIG. 29 illustrates network latency results for balanced OBSS.

FIG. 30 illustrates gaming round trip time (RTT) latency results for balanced OBSS.

FIG. 31 illustrates video conference latency results for balanced OBSS.

FIG. 32 illustrates video streaming throughput results for balanced OBSS.

FIG. 33 illustrates network latency results for unbalanced OBSS.

FIG. 34 illustrates gaming RTT latency results for unbalanced OBSS.

FIG. 35 illustrates video conference latency results for balanced OBSS.

FIG. 36 illustrates video streaming throughput results for balanced OBSS.

FIG. 37 illustrates network latency results for unequal priority.

FIG. 38 illustrates gaming RTT latency results for unequal priority.

FIG. 39 illustrates video conference latency results for unequal priority.

FIG. 40 illustrates video streaming throughput results for unequal priority.

### DETAILED DESCRIPTION

The packet exchange between an Access Point (AP) and Station (STA) nodes in an IEEE 802.11 network may be sequenced with a previously granted Transmit Opportunity (TXOP). The sequence provided by the TXOP allows for the scheduling of different downlink (DL) and uplink (UL) transactions for execution, which may facilitate specific guarantees provided by the quality of service (QOS) for different network applications. For example, virtual reality glasses using a wireless data interface may periodically exchange data in the uplink and downlink direction (i.e., downlink may be audio and video data sent to the user and uplink may be position and audio data sent from the user) with a specific transmission reliability and bounded latency for the correct functionality.

In upper layer transmission control protocol (TCP) based packet exchange, each data transmission may be associated with an acknowledgment TCP packet. The AP may sequence the transactions to schedule the transmission of a TCP data packet, and, in the next transaction, schedule the reception of the corresponding TCP acknowledgement packet. TCP based packet exchange may not facilitate a specific bounded latency for correct functionality.

To balance a specific transmission reliability with a specific latency, DL and UL signals may be transmitted based on the IEEE 802.11 standard. The scheduler may determine channel access by attending to the application's QoS. However, from the point of view of QoS, wireless links may be independent. When an AP transmits a frame to an STA, the AP may access the channel based on a TXOP and the repeater may receive the frame. In another operation, a repeater facilitating communication between the AP and the STA may use an additional TXOP to provide the AP frame to the STA. When an application uses a bounded latency (e.g., virtual reality glasses), these network topologies in which each basic service set (BSS) uses its own scheduler for the TXOP may degrade the QoS.

The AP and the repeater may be synchronized to start executing their transaction sequences at defined time instants. The end-to-end communication link (e.g., the communication link between the AP and the STA) may use coordinating scheduling for both BSS network segments.

A method for maintaining a latency between a first network segment and a second network segment may include synchronizing a timing for an access point and a first wireless device (e.g., another access point, a repeater, a STA, or the like). The method may further include determining transmit opportunity (TXOP) scheduling for the access point and the first wireless device. The method may further include transmitting data from the access point to a second wireless device (e.g., another access point, a repeater, a STA, or the like). The method may further include transmitting the data from the second wireless device to the first wireless device.

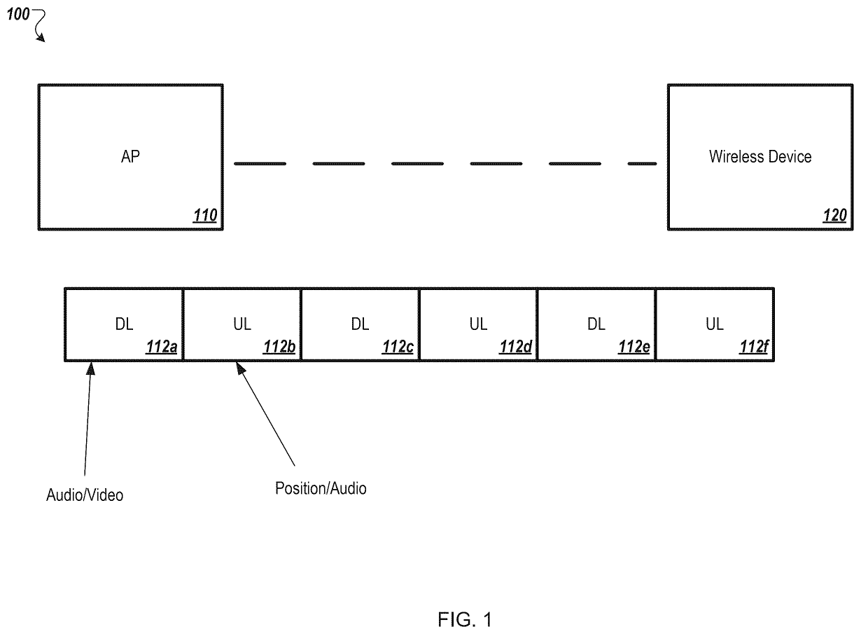

As illustrated in FIG. 1, a communication system 100 may include an AP 110 that may be configured to communicate with a wireless device 120. The wireless device may be another AP, a repeater, a STA, or the like. Downlink and uplink signals may be communicated between the AP 110 and the wireless device 120. When the signal is sent from the AP 110 to the wireless device 120, the signal may be a downlink signal. When the signal is sent from the wireless device 120 to the AP 110, the signal may be an uplink signal. The downlink signals 112a, 112c, 112e and the uplink signals 112b, 112d, 112f may include various data. For example, DL 112a may include audio data and video data that may be transmitted to the wireless device 120 from the AP 110. In another example, UL 112b may include position data and audio data which may be communicated from the wireless device 120 to the access point 110.

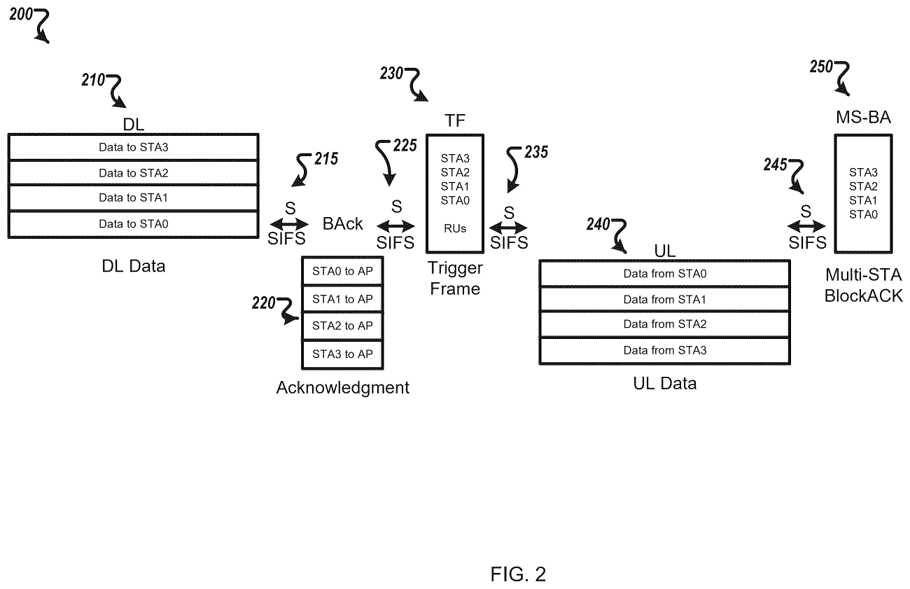

As illustrated in FIG. 2, a block diagram 200 for two consecutive trigger-based downlink and uplink transactions is provided. The control signaling used for orthogonal frequency division multiple access (OFDMA) multi-user resource allocation and acknowledgment frames is also shown. DL data 210 may be transmitted to one or more STAs (e.g., STA0, STA1, STA2, STA3). The one or more STAs (e.g., STA0, STA1, STA2, STA3) may provide an acknowledgment 220 to the AP. A trigger frame 230 in STA0, STA1, STA2, STA3 may be activated. Consequently, UL Data 240 may be sent from STA0, STA1, STA2, STA3 to the AP. STA0, STA1, STA2, STA3 may use a multi-STA block 250. Each of the signals may be separated by a short interframe space 215, 225, 235, 245.

The IEEE 802.11 standard provides for requesting QoS guarantees. An STA may send a Stream Classification Service (SCS) request for a specific application data stream, indicating the maximum latency and throughput used. The AP scheduler may interpret the request, and when allocating the resources, the AP may accept the request while the data stream attempts to meet the established QoS.

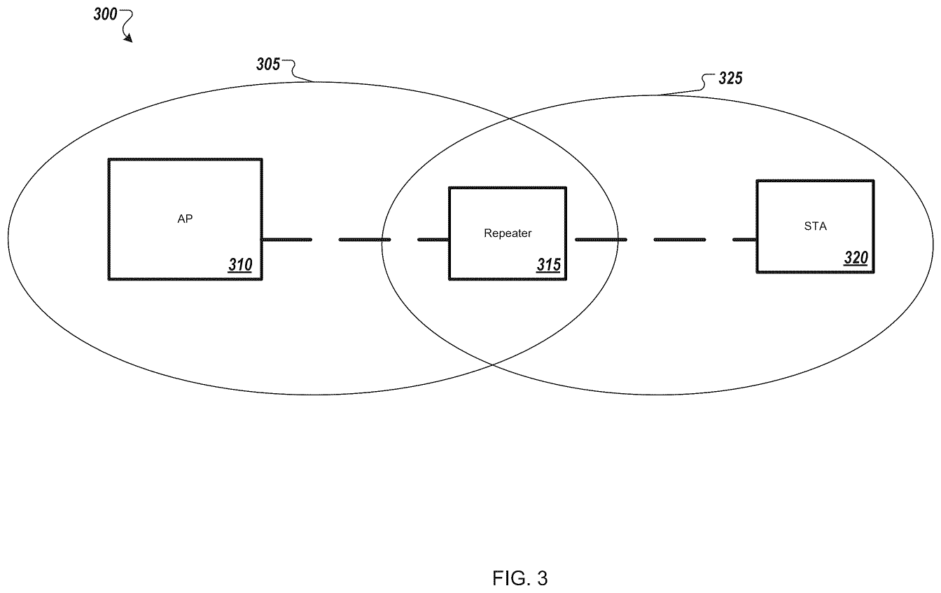

As illustrated in FIG. 3, a communication system 300 may include an AP 310 and an STA 320. The AP 310 and STA 320 network nodes may be operable to communicate using a wireless intermediary. That is, to extend the radio coverage of the AP 310 to reach the STA 320, a repeater 315 may be used. A repeater 315 may be located between the AP 310 and STA 320. The repeater 315 may have a communication link with both the AP 310 and with the STA 320. The repeater 315 may forward the received frames in both the uplink direction (e.g., from the STA 320 to the AP 310) and in the downlink direction (e.g., from the AP 310 to the STA 320). The repeater 315 facilitate communication between the AP (having BSS 305) with STA 320 (having BSS 325) when the path-loss propagation is high.

The repeater 315 may function as an AP 310 when the repeater 315 is communicating with the STA 320 and the repeater 315 may function as a STA 320 when the repeater 315 is communicating with the AP 310. Because there is no medium access control (MAC)/physical layer (PHY) level coordination between the AP 310 and the STA 320, the AP 310 and the STA 320 may have a separate Basic Service Set (BSS) which may cause interference based on the band and/or channel selection for the separate BSS networks.

Therefore, coordinated scheduling may reduce interference and increase latency. An access point (AP) may include a processing device operable to: determine, at the access point, an assigned time for the access point and a wireless device. The processing device may be operable to receive, at the access point, a TXOP. The processing device may be operable to identify, at the access point, scheduling information for the TXOP. The TXOP may be partitioned into a plurality of TXOP partitions including first TXOP partitions associated with the access point and second TXOP partitions associated with the wireless device. The processing device may be operable to provide, from the access point to the wireless device, scheduling information for the TXOP. The TXOP may be divided using Coordinated Time Division Multiple Access (TDMA), which may divide a gained TXOP and/or assign portions of that time to the respective wireless devices (e.g., an AP, a repeater, a STA, or the like).

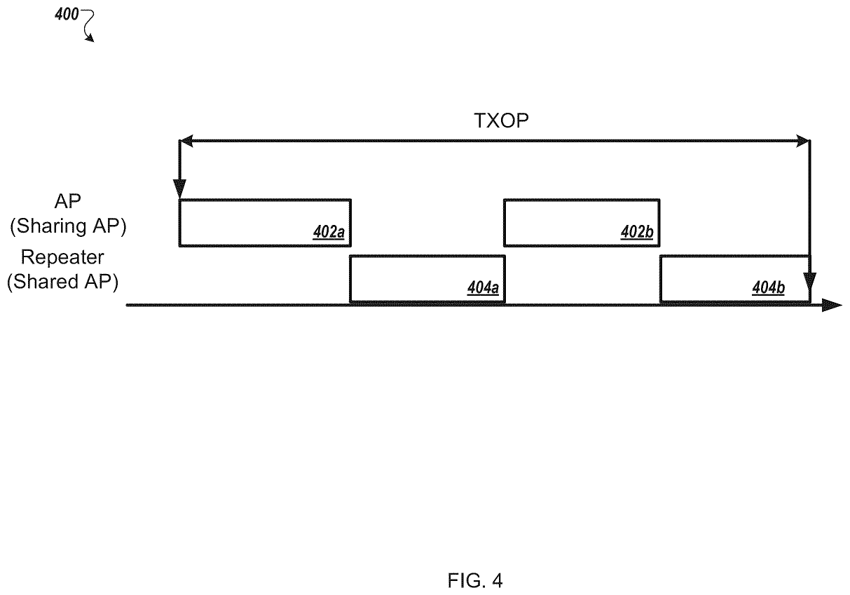

As illustrated in FIG. 4, an AP (e.g., sharing AP) and a wireless device (e.g., shared AP which may be an additional AP, a repeater, a STA, or the like) may operate in the same time window 400, but not simultaneously (i.e., without overlapping in time). The AP, as a coordinator, may control the channel and pass off control to the wireless device which may control the channel for the remaining time. Therefore, the operations of AP and the wireless device may not overlap in time. That is, the AP may be operable during time periods 402a, 402b in a TXOP and the wireless device may be operable during time periods 404a, 404b in the TXOP.

The access point may provide scheduling information for the TXOP using triggered TXOP sharing. The triggered TXOP sharing feature from IEEE 802.11 may be modified to allow the AP to share its own TXOP time to the wireless device (e.g., another AP, a repeater, a STA, or the like). In this way, an AP may execute its assigned transaction sequence without overlapping in time with the wireless device using the same TXOP.

The AP may be operable to synchronize the timing for the AP and the wireless device using one or more of: a trigger frame from the access point as an initial time reference, or a synchronized internal timer for AP and a synchronized internal timer for the wireless device. Before scheduling information for the TXOP is exchanged between the AP and a wireless device, the AP and the wireless device may agree on an assigned time using one or more control messages. The control messages may include the configuration for the TDMA.

There are two options to time synchronize the operations of the AP and the wireless device, to prevent overlap in time during the TXOP. In one example, the first trigger frame from the AP may be used as an initial time reference to execute the operations based on the time offset from the initial time reference. The wireless device may receive the signaling from the AP.

In another example, the AP and the wireless device may determine that a scheduled coordinated access may occur. The AP and the wireless device may synchronize their internal timing synchronization function (TSF) timers to have the same time reference. Therefore the wireless device (e.g., shared AP) may prepare the transactions before the transactions are executed.

The AP may be operable to synchronize the timing for the access point and the wireless device using TSF from a repeater in communication with the access point and the wireless device. TSF time synchronization may be implemented by, e.g., time synchronizing an additional wireless device (e.g., an STA) from the wireless device (e.g., a repeater). Based on the IEEE 802.11 standard the AP beacon frame may be used to propagate the timer value to the one or more of the AP or the additional wireless device from the wireless device (e.g., a repeater).

In one example, a repeater may include a processing device operable to synchronize, at the repeater, a timing for the repeater and an access point. The processing device may be operable to receive, from an access point, scheduling information for a transmit opportunity (TXOP). The processing device may be operable to receive, at the repeater, data from the access point. The processing device may be operable to transmit, from the repeater to a station (STA), the data. The processing device may be operable to receive, from the STA, additional data. The processing device may be operable to transmit, from the repeater to the access point, the additional data. The timing between the repeater and the access point may be synchronized using TSF.

When the AP, the wireless device, and/or the additional wireless device have coordinated access to the channel, execution may be scheduled. For the examples of an access point, a repeater, and a STA, execution may proceed as follows.

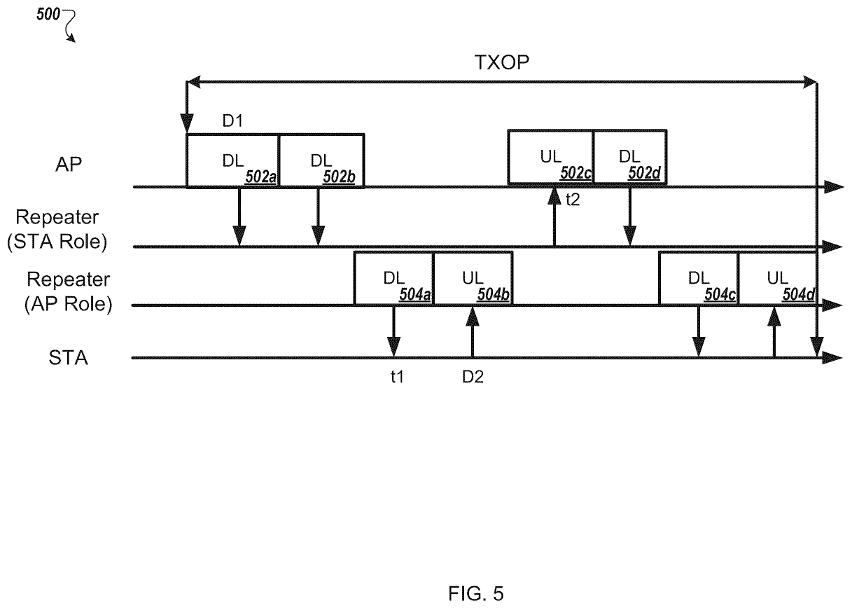

FIG. 5 show the execution of a coordinated scheduling between the AP and repeater (i.e., having a STA role and an AP role). The AP may exchange data Di in DL 502a and DL 502b with the repeater (STA role). The repeater may exchange data Di in DL 504a with the STA at time t₁. That is, the data D₁ originated in the AP and may be communicated to the STA at time t₁, and the data D₂ in UL 504b may be sent from the STA in UL 504b to the repeater for arrival at the AP at time t₂ in UL 502c. The process may be repeated one or more times as shown by DL 502d, DL 504c, and UL 504d.

Endpoint to endpoint (E2E) data exchange between the AP and a wireless device (e.g., another AP, a repeater, a STA, or the like) may be predictable when the schedulers are synchronized and coordinated. When the wireless device requests an SCS configuration, the AP may authorize the wireless device as a coordination manager to coordinate the scheduling flows between the AP and the wireless device which may use a common scheduler to be partitioned to different wireless devices (e.g., APs, repeaters, STAs, or the like).

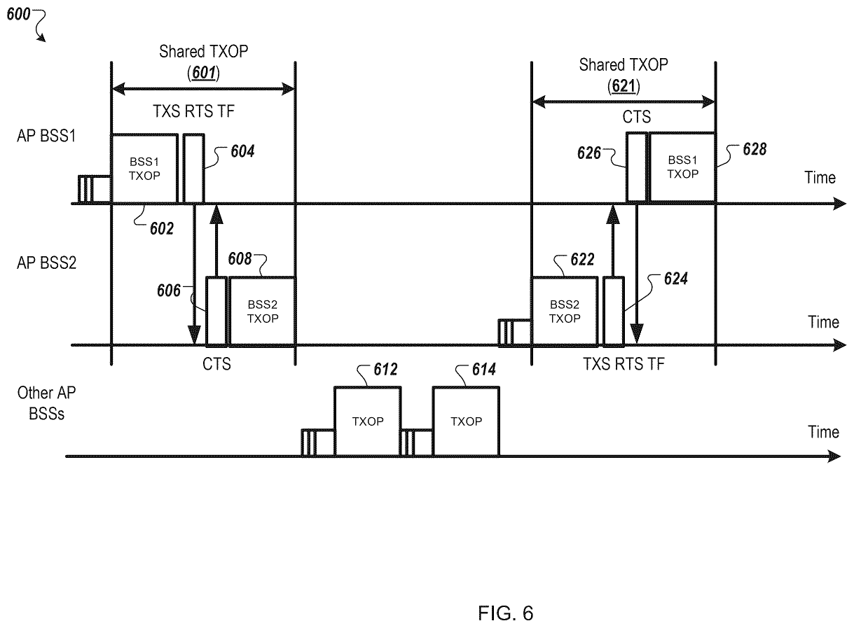

FIG. 6 shows coordinated TDMA, which allows cooperation of two APs by sharing a gained TXOP between them. AP BSS1 and AP BSS2 may use the gained time to reduce the waiting time to access the channel. Reducing the waiting time to access the channel may reduce the latency of different traffic flows (e.g., for traffic flows having a higher priority access category).

The timing diagram 600 shows how a TXOP is shared for the uplink scenario and the downlink scenario. For example, shared TXOP 601 is shared by the AP BSS1 (the sharing BSS) and the AP BSS2 (the shared BSS). The BSS1 TXOP 602 may be allocated a selected amount of time in the shared TXOP 601. A TXOP sharing request to send trigger frame (TXS RTS TF) 604 may be communicated from the AP BSS1 to the AP BSS2 after BSS1 TXOP 602. In response, the AP BSS2 may send a clear to send (CTS) 606 to the AP BSS1. AP BSS2 may proceed with communication in BSS2 TXOP 608 after sending the CTS to the AP BSS1.

After the communication in BSS2 TXOP 608 between AP BSS1 and AP BSS2, other AP BSSs may also transmit in TXOPs. For example, TXOP 612 and TXOP 614 may be used by various other AP BSSs.

AP BSS1 may also be a shared AP as shown with reference to shared TXOP 621. BSS2 TXOP 622 may be transmitted in by AP BSS2. Following this transmission, a TXS RTS TF 624 may be communicated from AP BSS2 to AP BSS1. In response, AP BSS1 may send a CTS 626 to AP BSS2. AP BSS1 may continue by transmitting in BSS1 TXOP 628.

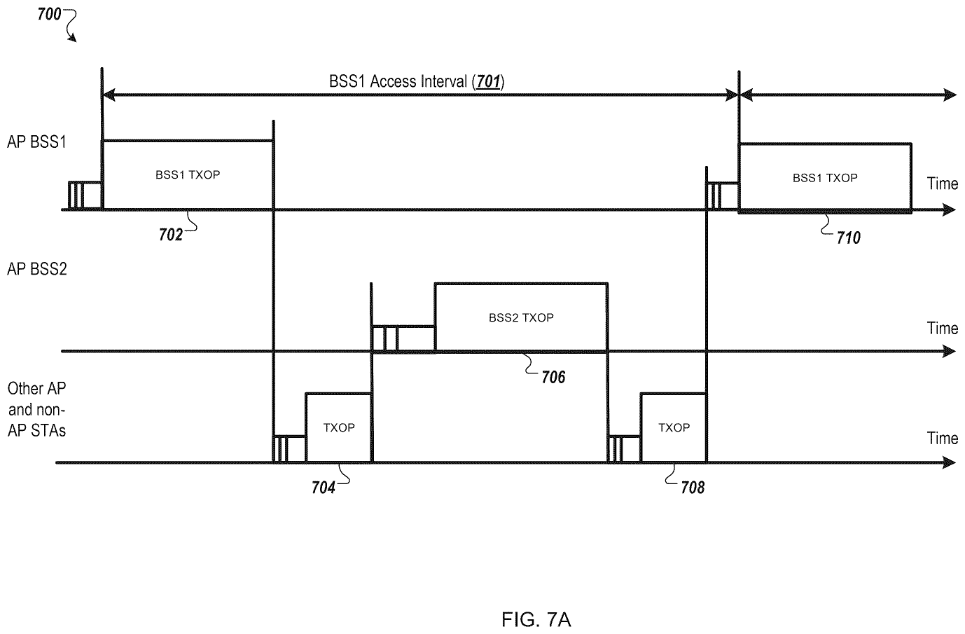

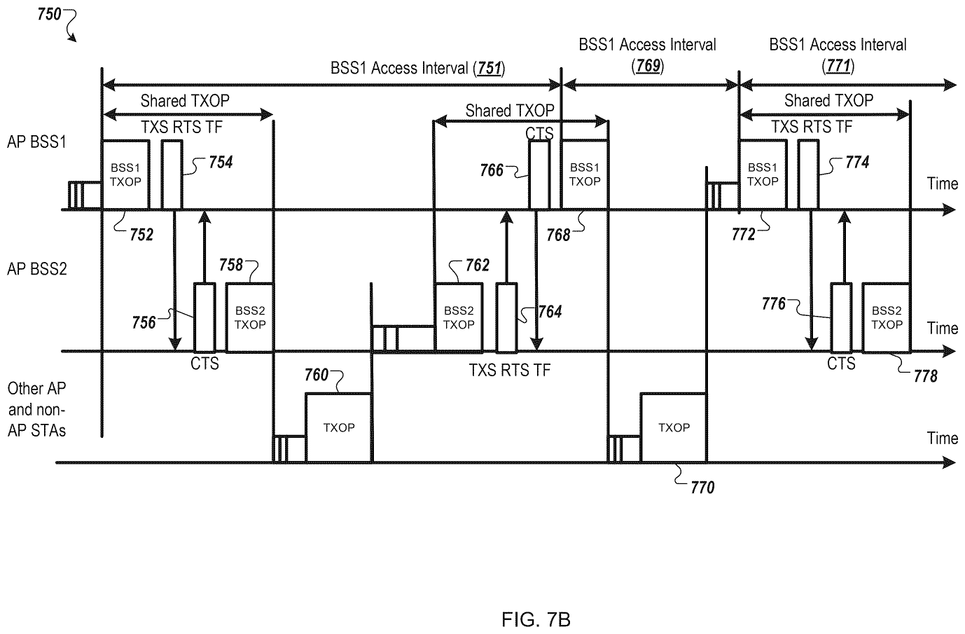

FIGS. 7A and 7B illustrates a comparison between uncoordinated TDMA (FIG. 7A) and coordinated TDMA (FIG. 7B). In uncoordinated TDMA, a timing diagram 700 shows that a BSS1 access interval 701 may be congested. For example, a BSS1 TXOP 702 may be assigned, a TXOP 704 may be assigned to other AP and non-AP STAs, a BSS2 TXOP may be assigned, a TXOP 708 may be assigned to other AP and non-AP STAs, and a BSS1 TXOP 710 may be assigned. Because of the proximity of TXOP 704 to BSS1 TXOP 702 and BSS2 TXOP 706 and because of the proximity of TXOP 708 to BSS2 TXOP 706 and to BSS1 TXOP 710, TXOP 704 and TXOP 708 may be congested.

FIG. 7B illustrates a reduction in latency by reducing the access time for the shared AP. In the timing diagram 750, the BSS1 access interval 751 may reduce the latency without changing the time used per BSS. A shared TXOP may include a BSS1 TXOP 752, a TXS RTS TF 754 (which may be communicated from the AP BSS1 to the AP BSS2), a CTS 756 (which may be communicated from the AP BSS2 to the AP BSS1), and a BSS2 TXOP 758. The shared TXOP may be followed by a TXOP 760 for other AP and non-AP STAs.

The BSS 1 access interval 751 may also include a BSS2 TXOP 762 in another shared TXOP, a TXS RTS TF 764 (which may be communicated from AP BSS2 to AP BSS1), and a CTS 766 (which may be communicated from AP BSS1 to AP BSS2). The BSS1 TXOP 768 may be part of a different BSS1 access interval 769. BSS1 access interval 769 may also include TXOP 770 for other AP and non-AP STAs.

An additional BSS1 access interval 771 may include BSS1 TXOP 772, TXS RTS TF 774 (which may be communicated from AP BSS1 to AP BSS2), CTS 776 (which may be communicated from AP BSS2 to AP BSS1), and BSS2 TXOP 778. Therefore, coordinated TDMA allows for a reduction in latency without reducing the time allocated for the APs.

In one example, a network topology may include n additional wireless devices such as one or more repeaters, one or more access points, one or more STAs, or the like. That is a larger network may be used such as a mesh network (i.e., more than 2 devices).

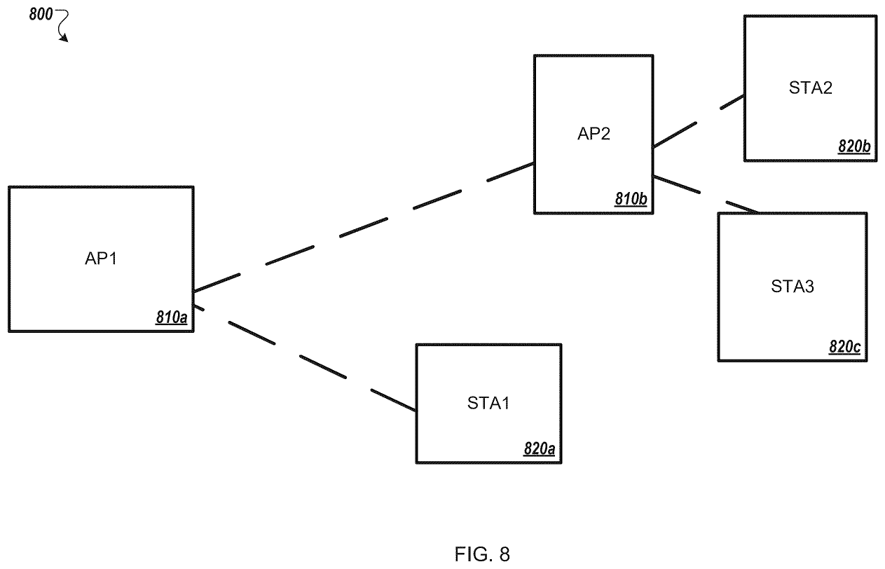

As illustrated in FIG. 8, a network topology 800 may include one or more of a first access point 810a, a second access point 810b, a first STA 820a, a second STA 820b, or a third STA 820c. One or more of an access point, a repeater, or a STA may be operable to synchronize a timing for n additional wireless devices. The TXOP may be partitioned into n TXOP partitions associated with the n additional wireless devices.

An E2E quality of service (QoS) guarantee may be facilitated in a plurality of network segments. That is, for a multiple AP topology, an E2E QoS may be guaranteed to facilitate a threshold latency and throughput.

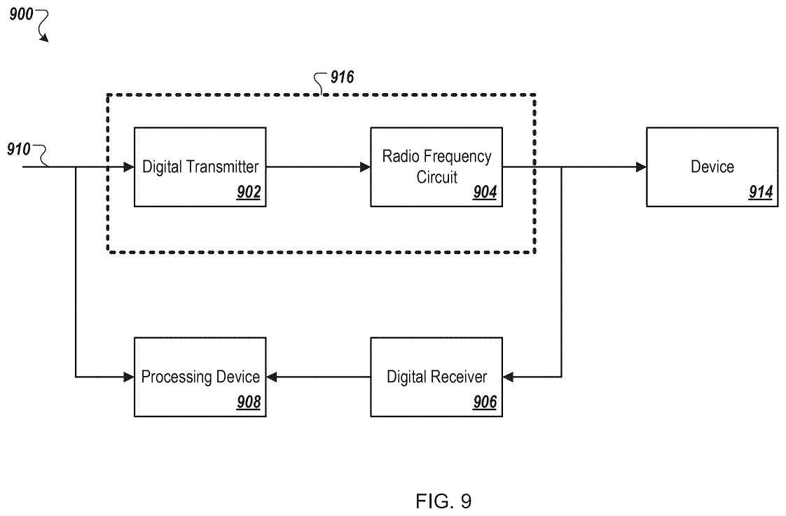

FIG. 9 illustrates a block diagram of an example communication system 900 configured for coordinated scheduling, in accordance with at least one example described in the present disclosure. The communication system 900 may include a digital transmitter 902, a radio frequency circuit 904, a device 914, a digital receiver 906, and a processing device 908. The digital transmitter 902 and the processing device may be configured to receive a baseband signal via connection 910. A transceiver 916 may comprise the digital transmitter 902 and the radio frequency circuit 904.

In some examples, the communication system 900 may include a system of devices that may be configured to communicate with one another via a wired or wireline connection. For example, a wired connection in the communication system 900 may include one or more Ethernet cables, one or more fiber-optic cables, and/or other similar wired communication mediums. Alternatively, or additionally, the communication system 900 may include a system of devices that may be configured to communicate via one or more wireless connections. For example, the communication system 900 may include one or more devices configured to transmit and/or receive radio waves, microwaves, ultrasonic waves, optical waves, electromagnetic induction, and/or similar wireless communications. Alternatively, or additionally, the communication system 900 may include combinations of wireless and/or wired connections. In these and other examples, the communication system 900 may include one or more devices that may be configured to obtain a baseband signal, perform one or more operations to the baseband signal to generate a modified baseband signal, and transmit the modified baseband signal, such as to one or more loads.

In some examples, the communication system 900 may include one or more communication channels that may communicatively couple systems and/or devices included in the communication system 900. For example, the transceiver 916 may be communicatively coupled to the device 914.

In some examples, the transceiver 916 may be configured to obtain a baseband signal. For example, as described herein, the transceiver 916 may be configured to generate a baseband signal and/or receive a baseband signal from another device. In some examples, the transceiver 916 may be configured to transmit the baseband signal. For example, upon obtaining the baseband signal, the transceiver 916 may be configured to transmit the baseband signal to a separate device, such as the device 914. Alternatively, or additionally, the transceiver 916 may be configured to modify, condition, and/or transform the baseband signal in advance of transmitting the baseband signal. For example, the transceiver 916 may include a quadrature up-converter and/or a digital to analog converter (DAC) that may be configured to modify the baseband signal. Alternatively, or additionally, the transceiver 916 may include a direct radio frequency (RF) sampling converter that may be configured to modify the baseband signal.

In some examples, the digital transmitter 902 may be configured to obtain a baseband signal via connection 910. In some examples, the digital transmitter 902 may be configured to up-convert the baseband signal. For example, the digital transmitter 902 may include a quadrature up-converter to apply to the baseband signal. In some examples, the digital transmitter 902 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 902.

In some examples, the transceiver 916 may include one or more subcomponents that may be used in preparing the baseband signal and/or transmitting the baseband signal. For example, the transceiver 916 may include an RF front end (e.g., in a wireless environment) which may include a power amplifier (PA), a digital transmitter (e.g., 902), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 904) of the transceiver 916 may be synchronized with the resource controller via the S-plane device, which may contribute to high-accuracy timing with respect to a reference clock.

In some examples, the transceiver 916 may be configured to obtain the baseband signal for transmission. For example, the transceiver 916 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 916 may be configured to generate a baseband signal for transmission. In these and other examples, the transceiver 916 may be configured to transmit the baseband signal to another device, such as the device 914.

In some examples, the device 916 may be configured to receive a transmission from the transceiver 916. For example, the transceiver 916 may be configured to transmit a baseband signal to the device 914.

In some examples, the radio frequency circuit 904 may be configured to transmit the digital signal received from the digital transmitter 902. In some examples, the radio frequency circuit 904 may be configured to transmit the digital signal to the device 914 and/or the digital receiver 906. In some examples, the digital receiver 906 may be configured to receive a digital signal from the RF circuit and/or send a digital signal to the processing device 908.

In some examples, the processing device 908 may be a standalone device or system, as illustrated. Alternatively, or additionally, the processing device 908 may be a component of another device and/or system. For example, in some examples, the processing device 908 may be included in the transceiver 916. In instances in which the processing device 908 is a standalone device or system, the processing device 908 may be configured to communicate with additional devices and/or systems remote from the processing device 908, such as the transceiver 916 and/or the device 914. For example, the processing device 908 may be configured to send and/or receive transmissions from the transceiver 916 and/or the device 914. In some examples, the processing device 908 may be combined with other elements of the communication system 900.

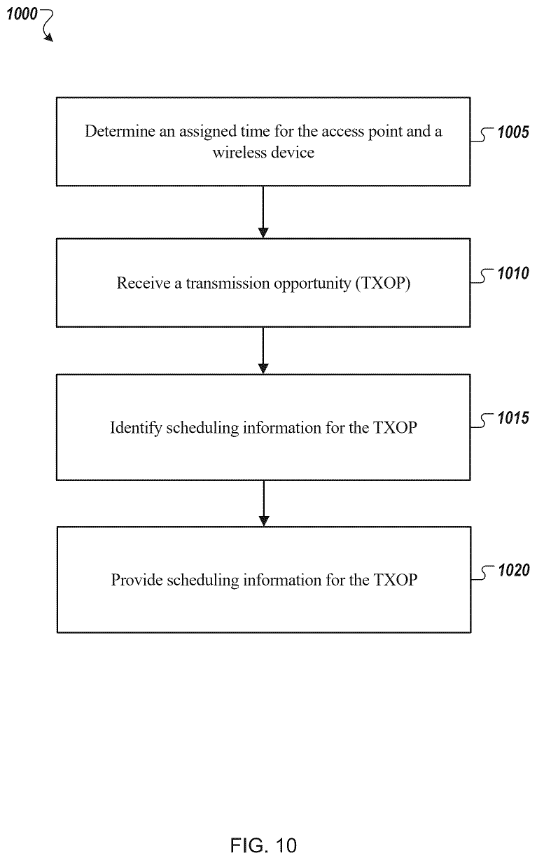

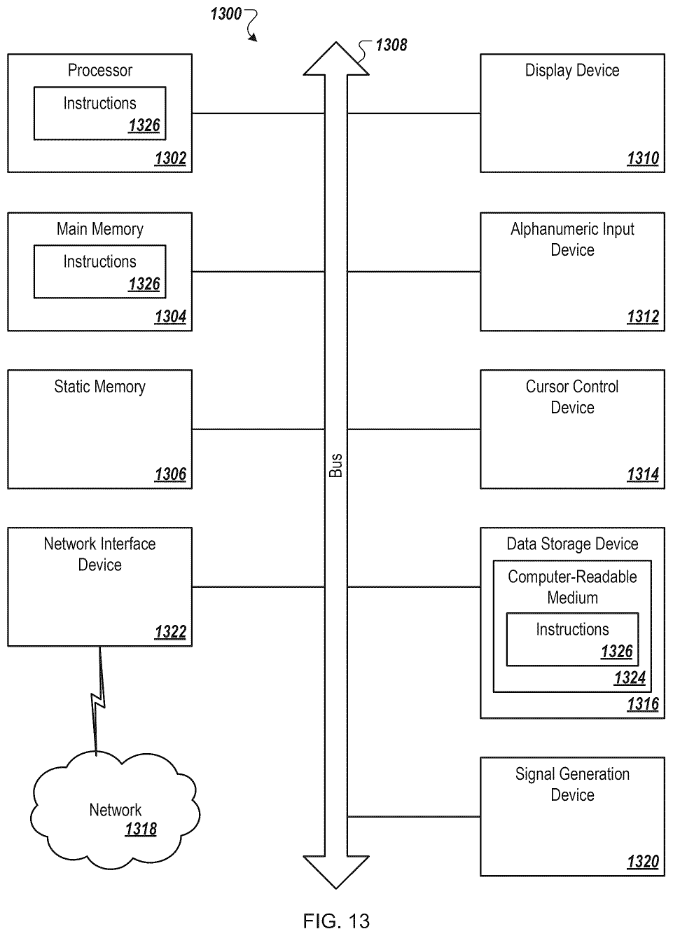

FIG. 10 illustrates a process flow of an example method 1000 of coordinated scheduling actuation, in accordance with at least one example described in the present disclosure. The method 1000 may be arranged in accordance with at least one example described in the present disclosure. The method 1000 may be performed by processing logic that may include hardware (circuitry, dedicated logic, etc.), software (such as is run on a computer system or a dedicated machine), or a combination of both, which processing logic may be included in the processing device 1302 of FIG. 13, the communication system 900 of FIG. 9, or another device, combination of devices, or systems.

The method 1000 may begin at block 1005 where the processing logic may determine, at the access point, an assigned time for the access point and a wireless device.

At block 1010, the processing logic may receive, at the access point, a transmission opportunity (TXOP).

At block 1015, the processing logic may identify, at the access point, scheduling information for the TXOP, wherein the TXOP is partitioned into a plurality of TXOP partitions comprising first TXOP partitions associated with the access point and second TXOP partitions associated with the wireless device

At block 1020, the processing logic may provide, from the access point to the wireless device, scheduling information for the TXOP.

Modifications, additions, or omissions may be made to the method 1000 without departing from the scope of the present disclosure. For example, in some examples, the method 1000 may include any number of other components that may not be explicitly illustrated or described.

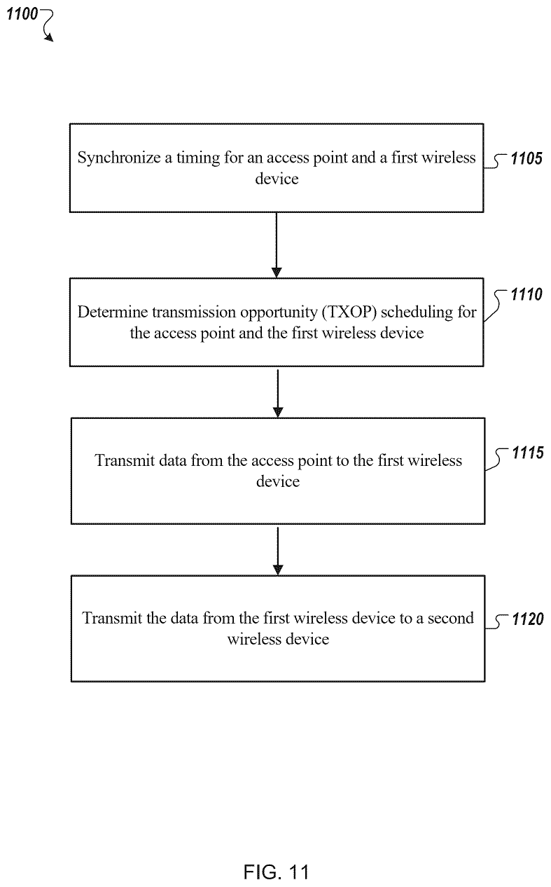

FIG. 11 illustrates a process flow of an example method 1100 of coordinated scheduling actuation, in accordance with at least one example described in the present disclosure. The method 1100 may be arranged in accordance with at least one example described in the present disclosure.

The method 1100 may be performed by processing logic that may include hardware (circuitry, dedicated logic, etc.), software (such as is run on a computer system or a dedicated machine), or a combination of both, which processing logic may be included in the processing device 1302 of FIG. 13, the communication system 900 of FIG. 9, or another device, combination of devices, or systems.

The method 1100 may begin at block 1105 where the processing logic may synchronize a timing for an access point and a first wireless device.

At block 1110, the processing logic may determine transmission opportunity (TXOP) scheduling for the access point and the first wireless device.

At block 1115, the processing logic may transmit data from the access point to the first wireless device.

At block 1120, the processing logic may transmit the data from the first wireless device to a second wireless device.

The processing logic may synchronize the timing for the access point and the first wireless device using one or more of: a trigger frame from the access point as an initial time reference, or a synchronized internal timer for access point and a synchronized internal timer for the first wireless device.

The processing logic may synchronize the timing for the access point and the first wireless device using TSF from the first wireless device in communication with the access point and the second wireless device.

The processing logic may determine TXOP scheduling by partitioning the TXOP into a plurality of TXOP partitions comprising first TXOP partitions associated with the access point and second TXOP partitions associated with the first wireless device.

The processing logic may determine TXOP scheduling by partitioning the TXOP into n sets of TXOP partitions, wherein each of the n sets of TXOP partitions is associated with n additional wireless devices.

In some examples, one or more of the first wireless device or the second wireless device may be one or more of a repeater, an additional access point, or a station (STA).

Modifications, additions, or omissions may be made to the method 1100 without departing from the scope of the present disclosure. For example, in some examples, the method 1100 may include any number of other components that may not be explicitly illustrated or described.

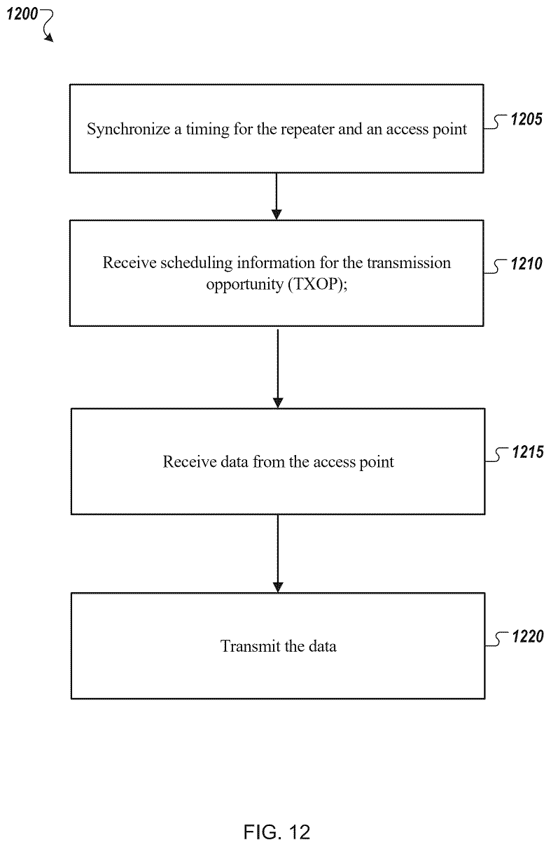

FIG. 12 illustrates a process flow of an example method 1200 of coordinated scheduling actuation, in accordance with at least one example described in the present disclosure. The method 1200 may be arranged in accordance with at least one example described in the present disclosure.

The method 1200 may be performed by processing logic that may include hardware (circuitry, dedicated logic, etc.), software (such as is run on a computer system or a dedicated machine), or a combination of both, which processing logic may be included in the processing device 1302 of FIG. 13, the communication system 900 of FIG. 9, or another device, combination of devices, or systems.

The method 1200 may begin at block 1205 where the processing logic may synchronize, at the repeater, a timing for the repeater and an access point.

At block 1210, the processing logic may receive, at the access point, scheduling information for a transmit opportunity (TXOP).

At block 1215, the processing logic may receive, at the repeater, data from the access point.

At block 1220, the processing logic may transmit, from the repeater to a station (STA), the data.

The process logic may receive, at the repeater from the STA, additional data; and transmit, from the repeater to the access point, the additional data. The process logic may: synchronize, at the repeater, a timing for the repeater and an access point using TSF. The process logic may synchronize, at the repeater, a timing for one or more additional wireless devices. The process logic may facilitate an end-to-end quality of service guarantee in a plurality of network segments.

Modifications, additions, or omissions may be made to the method 1200 without departing from the scope of the present disclosure. For example, in some examples, the method 1200 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 13 illustrates a diagrammatic representation of a machine in the example form of a computing device 1300 within which a set of instructions, for causing the machine to perform any one or more of the methods discussed herein, may be executed. The computing device 1300 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1300 includes a processing device (e.g., a processor) 1302, a main memory 1304 (e.g., read-only memory (ROM), flash memory, dynamic random access memory (DRAM) such as synchronous DRAM (SDRAM)), a static memory 1306 (e.g., flash memory, static random access memory (SRAM)) and a data storage device 1316, which communicate with each other via a bus 1308.

Processing device 1302 represents one or more general-purpose processing devices such as a microprocessor, central processing unit, or the like. More particularly, the processing device 1302 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1302 may also include one or more special-purpose processing devices such as an application specific integrated circuit (ASIC), a field programmable gate array (FPGA), a digital signal processor (DSP), network processor, or the like. The processing device 1302 is configured to execute instructions 1326 for performing the operations and steps discussed herein.

The computing device 1300 may further include a network interface device 1322 which may communicate with a network 1318. The computing device 1300 also may include a display device 1310 (e.g., a liquid crystal display (LCD) or a cathode ray tube (CRT)), an alphanumeric input device 1312 (e.g., a keyboard), a cursor control device 1314 (e.g., a mouse) and a signal generation device 1320 (e.g., a speaker). In at least one example, the display device 1310, the alphanumeric input device 1312, and the cursor control device 1314 may be combined into a single component or device (e.g., an LCD touch screen).

The data storage device 1316 may include a computer-readable storage medium 1324 on which is stored one or more sets of instructions 1326 embodying any one or more of the methods or functions described herein. The instructions 1326 may also reside, completely or at least partially, within the main memory 1304 and/or within the processing device 1302 during execution thereof by the computing device 1300, the main memory 1304 and the processing device 1302 also constituting computer-readable media. The instructions may further be transmitted or received over a network 1318 via the network interface device 1322.

While the computer-readable storage medium 1324 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

### EXAMPLES

The following provide examples of the performance characteristics according to embodiments of the present disclosure.

### Example 1A: Overlapping Basic Service Set (OBSS) Simulation

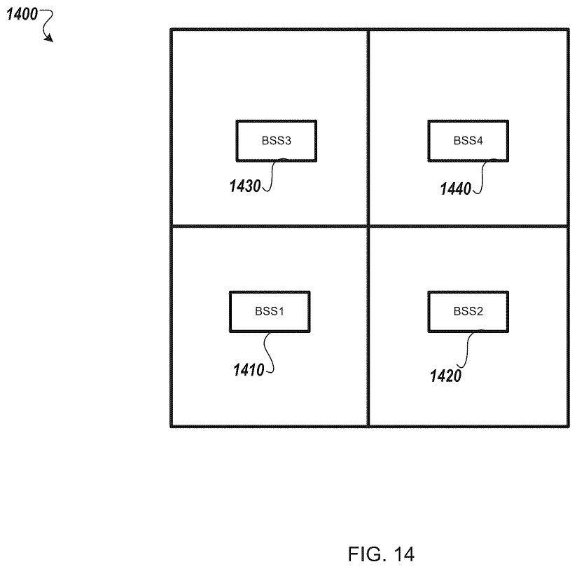

The experimental setup 1400 is illustrated as shown in FIG. 14. Coordinated time division multiple access (C-TDMA) was tested using an OBSS scenario in which there is coordination between at least one pair of independent neighboring BSSs sharing the same channel. The four squares refer to different apartments. Each apartment had an independent BSS (e.g., BSS1 1410, BSS2 1420, BSS3 1430, and BSS4 1440). Each BSS included one AP and 5 non-AP STAs. The OBSS STAs were in packet detect (PD) and energy detect (ED) range. The APs were in ED range.

There were three coordination scenarios: (1) uncoordinated (baseline), (2) BSS1/BSS2 coordinated, and (3) BSS1/BSS2 coordinated and BSS3/BSS4 coordinated.

The data frame PHY/MAC link configuration for associated STAs included: (1) single user (SU) 80 MHz/l service set (SS)/modulation and coding scheme (MCS):11 for creating overloading/saturation situation, and (2) SU 160 MHz/2SS/MCS:11 for creating underloading situation. The underload and overload situations were a combination of PHY settings, scheduling, data traffic, network topology, and AC settings.

The traffic generation used various services. First, STA1 service used video conference (downlink (DL), uplink (UL) 3 Mbps, 250 B length) using user datagram protocol (UDP) and video access class (VI_AC). Second, STA2 used video streaming at 4K ultra high definition (UHD) H264 (DL 32 Mbps, 1500 B length) using closed loop transmission control protocol (TCP) and VI_AC. Third, STA3 used gaming at DL/UL 140 kbps, periodicity 7 ms, 110 B length using UDP and voice access class (VO_AC). Fourth, STA4 used cloud file sync (DL/UL 10 Mbps, 1500 B length) using closed-loop TCP and best efforts access class (BE_AC). Fifth, STA5 used camera (UL 2 Mbps, 1450 B length) using UDP and VI_AC. TCP was used to generate TCP-ACK traffic (small length frames) and all the STAs generated UL traffic (using trigger based (TB) and EDCA mechanisms).

Two different approaches were used. For strategy 1, the remaining TXOP length was shared and after the sharing the AP local buffers were empty (for the gained and higher ACs). For strategy 2, the soft time threshold was set from higher layers (using managed networks). The sharing AP started sharing the TXOP before the time threshold if it had no more data, for the gained and higher ACs, in its BSS (case A). The sharing AP delayed sharing the TXOP if there was an ongoing data exchange that exceeded the time threshold (case B). A flexible maximum time length that the sharing AP could use for transferring data was defined, established by an external arbiter, while the rest was used by the shared AP. Both strategies ended the TXOP after the shared AP finished. It could be a premature termination sending the CF-End frame. A dynamic TXOP sharing ratio calculation may also be determined.

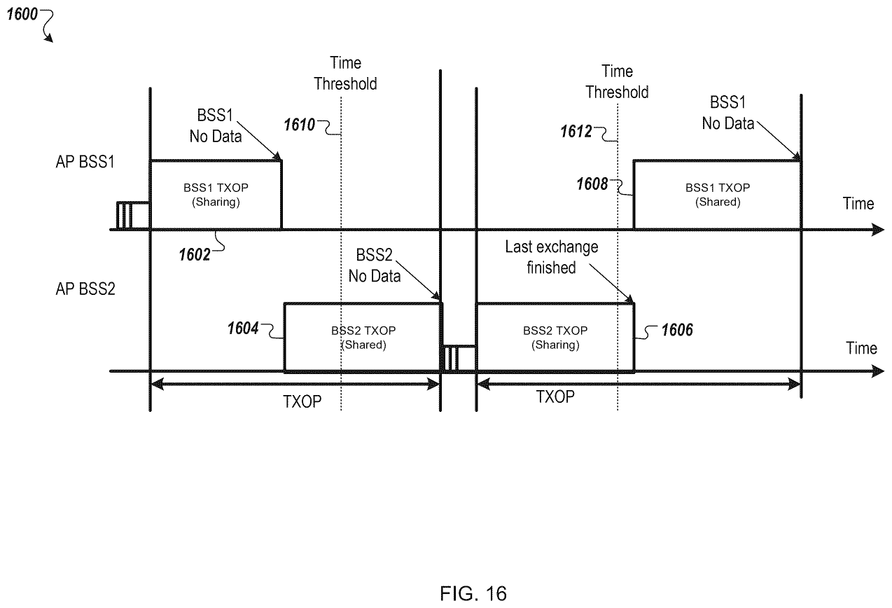

As illustrated in the timing diagram 1600 in FIG. 16, a first TXOP may include a BSS1 TXOP 1602 for the sharing AP (e.g., AP BSS1) and a BSS2 TXOP 1604 for the shared AP (e.g., AP BSS2). A time threshold 1610 may be determined during the first TXOP. A second TXOP may include a BSS2 TXOP 1606 for the sharing AP (e.g., AP BSS2) and a BSS1 TXOP 1608 for the shared AP (e.g., AP BSS1). A time threshold 1612 may be determined during the second TXOP. Control frame exchanges were removed for simplification, but the control frames were still present.

### Overall Network Results

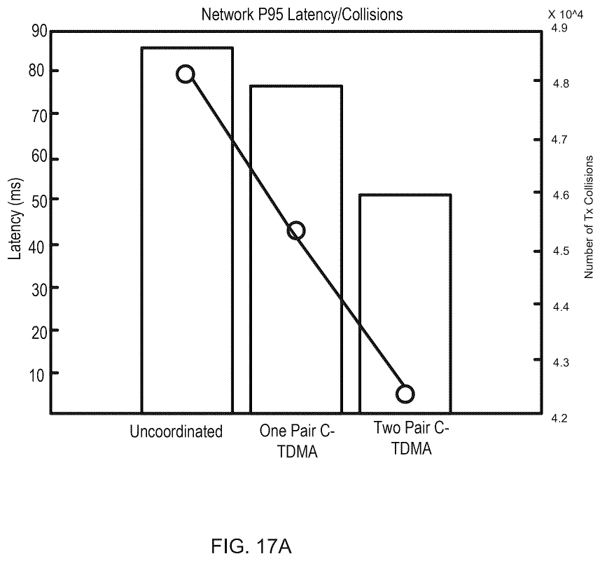

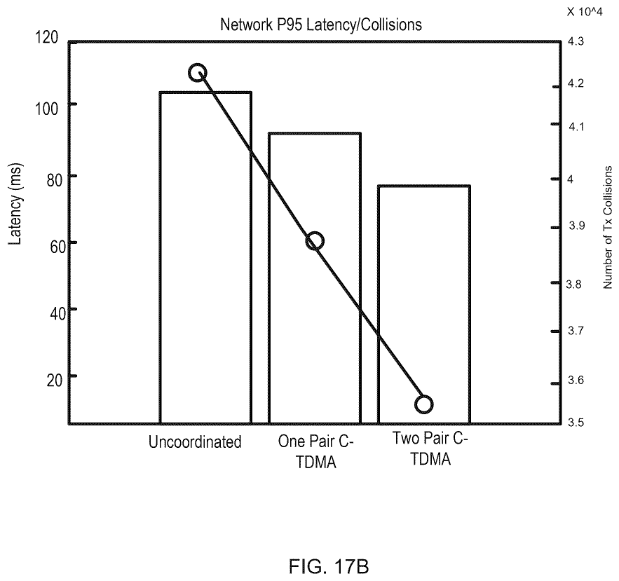

As illustrated in FIGS. 17A and 17B, overall network results for OBSS are provided. For the network overloaded saturated situation, in FIG. 17A, a chart of latency is provided alongside a chart of number of TX collisions. For the uncoordinated case, the latency was about 88 ms. For the one pair C-TDMA case, the latency was about 78 ms. For the two pair C-TDMA case, the latency was about 50 ms. Therefore, the latency dropped dramatically among the different cases.

The number of TX collisions also dropped among the different use cases. For the uncoordinated case, the number of Tx collisions was about 80. For the one pair C-TDMA case, the number of TX collisions was about 40. For the two pair C-TDMA case, the number of TX collisions was about 3.

For the network underloaded situation in FIG. 17B, the latency and the number of collisions also dropped among the different cases. For the uncoordinated case, the latency was about 105 ms. For the one pair C-TDMA case, the latency was about 90 ms. For the two pair C-TDMA case, the latency was about 80 ms. Therefore, the latency dropped dramatically among the different cases.

The number of TX collisions also dropped among the different use cases. For the uncoordinated case, the number of Tx collisions was about 110. For the one pair C-TDMA case, the number of TX collisions was about 60. For the two pair C-TDMA case, the number of TX collisions was about 10.

For both network situations in FIGS. 17A and 17B, while C-TDMA is set up for Strategy 2 using a time threshold of 50% (over the total gained TXOP length), it can be observed a trend for overall network latency (P95) reduction, including the total number of collisions in the air, increasing the air usage efficiency.

### Gaming Results:

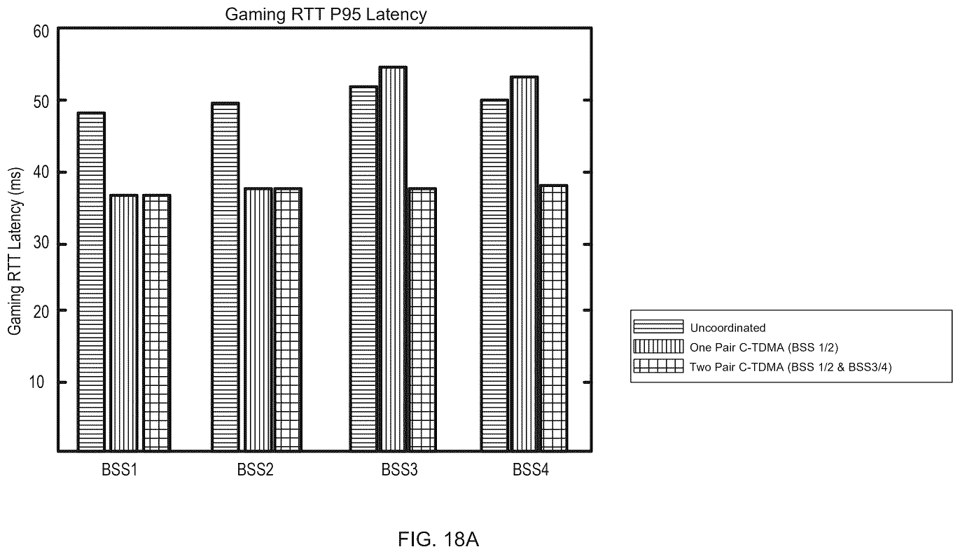

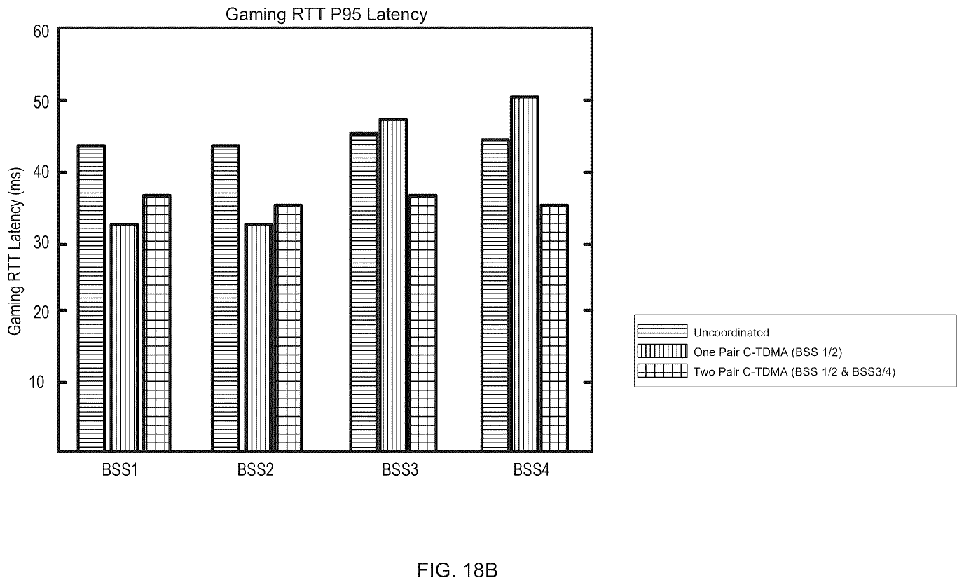

As illustrated in FIGS. 18A and 18B, the gaming round trip time (RTT) latency varied among the different cases (uncoordinated, one pair C-TDMA BSS 1/2, and two-pair C-TDMA BSS 1/2, and BSS 3/4).

As shown in FIG. 18A, for the network overloaded situation for uncoordinated C-TDMA, (i) for BSS1, the gaming RTT latency was about 48 ms, (ii) for BSS2, the gaming RTT latency was about 50 ms, (iii) for BSS3, the gaming RTT latency was about 52 ms, and (iv) for BSS4, the gaming RTT latency was about 50 ms. For one pair C-TDMA between BSS 1 and 2, (i) for BSS1, the gaming RTT latency was about 38 ms, (ii) for BSS2, the gaming RTT latency was about 38 ms, (iii) for BSS3, the gaming RTT latency was about 55 ms, and (iv) for BSS4, the gaming RTT latency was about 52 ms. For two pair C-TDMA between BSS 1 and 2 and between BSS 3 and 4, (i) for BSS1, the gaming RTT latency was about 38 ms, (ii) for BSS2, the gaming RTT latency was about 38 ms, (iii) for BSS3, the gaming RTT latency was about 39 ms, and (iv) for BSS4, the gaming RTT latency was about 39 ms.

As shown in FIG. 18B, for the network underloaded situation for uncoordinated C-TDMA, (i) for BSS1, the gaming RTT latency was about 45 ms, (ii) for BSS2, the gaming RTT latency was about 45 ms, (iii) for BSS3, the gaming RTT latency was about 47 ms, and (iv) for BSS4, the gaming RTT latency was about 47 ms. For one pair C-TDMA between BSS 1 and 2, (i) for BSS1, the gaming RTT latency was about 32 ms, (ii) for BSS2, the gaming RTT latency was about 32 ms, (iii) for BSS3, the gaming RTT latency was about 50 ms, and (iv) for BSS4, the gaming RTT latency was about 52 ms. For two pair C-TDMA between BSS 1 and 2 and between BSS 3 and 4, (i) for BSS1, the gaming RTT latency was about 38 ms, (ii) for BSS2, the gaming RTT latency was about 37 ms, (iii) for BSS3, the gaming RTT latency was about 38 ms, and (iv) for BSS4, the gaming RTT latency was about 38 ms.

For both network situations, it can be observed that when BSS1/BSS2 used C-TDMA, the latency was reduced by 20-30%, while the uncoordinated BSSs (BSS3/BSS4) were not affected by unfairness. The same latency gain is obtained when both BSS pairs coordinated their transmissions.

### Video Conference Results

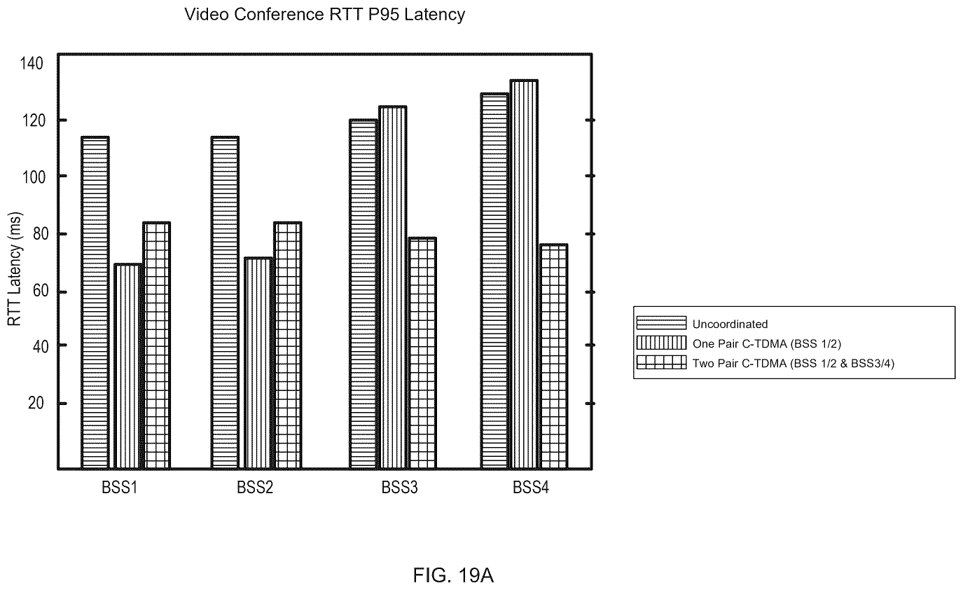

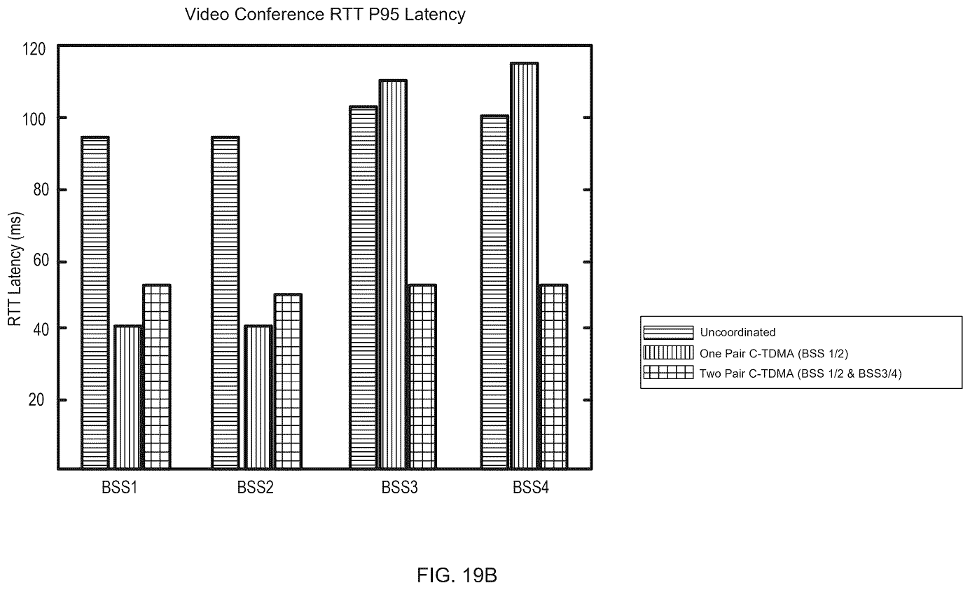

As illustrated in FIGS. 19A and 19B, the video conference RTT P95 latency varied among the different cases (uncoordinated, one pair C-TDMA BSS 1/2, and two-pair C-TDMA BSS 1/2, and BSS 3/4).

As shown in FIG. 19A, for the network overloaded situation for uncoordinated C-TDMA, (i) for BSS1, the video conference RTT P95 latency was about 110 ms, (ii) for BSS2, the video conference RTT P95 latency was about 115 ms, (iii) for BSS3, the video conference RTT P95 latency was about 120 ms, and (iv) for BSS4, the video conference RTT P95 latency was about 125 ms. For one pair C-TDMA between BSS 1 and 2, (i) for BSS1, the video conference RTT P95 latency was about 65 ms, (ii) for BSS2, the video conference RTT P95 latency was about 70 ms, (iii) for BSS3, the video conference RTT P95 latency was about 120 ms, and (iv) for BSS4, the video conference RTT P95 latency was about 130 ms. For two pair C-TDMA between BSS 1 and 2 and between BSS 3 and 4, (i) for BSS1, the video conference RTT P95 latency was about 80 ms, (ii) for BSS2, the video conference RTT P95 latency was about 80 ms, (iii) for BSS3, the video conference RTT P95 latency was about 75 ms, and (iv) for BSS4, the video conference RTT P95 latency was about 75 ms.

As shown in FIG. 19B, for the network underloaded situation for uncoordinated C-TDMA, (i) for BSS1, the video conference RTT P95 latency was about 95 ms, (ii) for BSS2, the video conference RTT P95 latency was about 95 ms, (iii) for BSS3, the video conference RTT P95 latency was about 100 ms, and (iv) for BSS4, the video conference RTT P95 latency was about 100 ms. For one pair C-TDMA between BSS 1 and 2, (i) for BSS1, the video conference RTT P95 latency was about 43 ms, (ii) for BSS2, the video conference RTT P95 latency was about 45 ms, (iii) for BSS3, the video conference RTT P95 latency was about 110 ms, and (iv) for BSS4, the video conference RTT P95 latency was about 115 ms. For two pair C-TDMA between BSS 1 and 2 and between BSS 3 and 4, (i) for BSS1, the video conference RTT P95 latency was about 50 ms, (ii) for BSS2, the video conference RTT P95 latency was about 50 ms, (iii) for BSS3, the video conference RTT P95 latency was about 55 ms, and (iv) for BSS4, the video conference RTT P95 latency was about 55 ms.

In a similar trend, the video conference latency results showed an improvement in the RTT latency by 40-60% with respect to the uncoordinated setup.

### Video Streaming Results

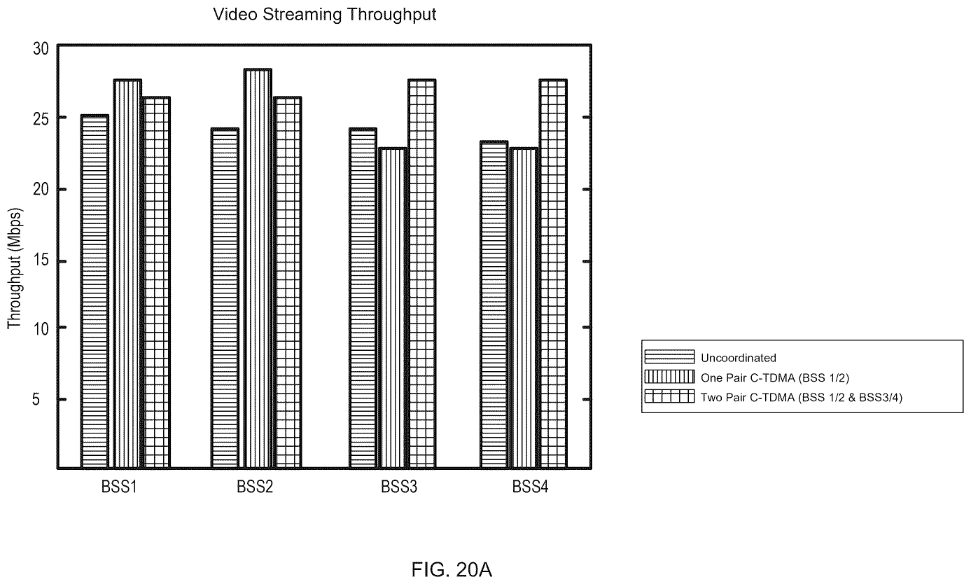

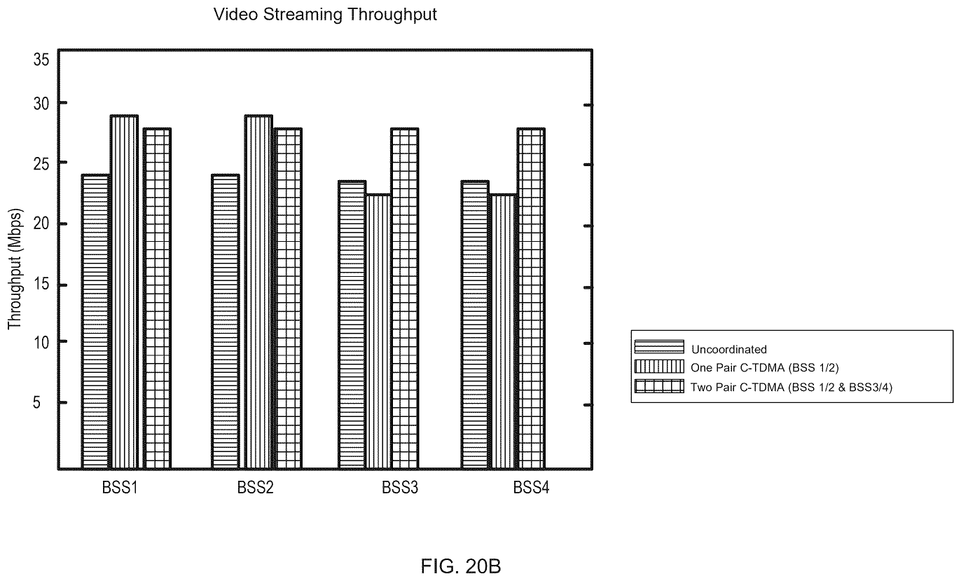

As illustrated in FIGS. 20A and 20B, the video streaming throughput varied among the different cases (uncoordinated, one pair C-TDMA BSS 1/2, and two-pair C-TDMA BSS 1/2, and BSS 3/4).

As shown in FIG. 20A, for the network overloaded situation for uncoordinated C-TDMA, (i) for BSS1, the video streaming throughput was about 24 Mbps, (ii) for BSS2, the video streaming throughput was about 23 Mbps, (iii) for BSS3, the video streaming throughput was about 23 Mbps, and (iv) for BSS4, the video streaming throughput was about 22 Mbps. For one pair C-TDMA between BSS 1 and 2, (i) for BSS1, the video streaming throughput was about 28 Mbps, (ii) for BSS2, the video streaming throughput was about 29 Mbps, (iii) for BSS3, the video streaming throughput was about 23 Mbps, and (iv) for BSS4, the video streaming throughput was about 23 Mbps. For two pair C-TDMA between BSS 1 and 2 and between BSS 3 and 4, (i) for BSS1, the video streaming throughput was about 27 Mbps, (ii) for BSS2, the video streaming throughput was about 27 Mbps, (iii) for BSS3, the video streaming throughput was about 28 Mbps, and (iv) for BSS4, the video streaming throughput was about 28 Mbps.

As shown in FIG. 20B, for the network underloaded situation for uncoordinated C-TDMA, (i) for BSS1, the video streaming throughput was about 26 Mbps, (ii) for BSS2, the video streaming throughput was about 26 Mbps, (iii) for BSS3, the video streaming throughput was about 25 Mbps, and (iv) for BSS4, the video streaming throughput was about 25 Mbps. For one pair C-TDMA between BSS 1 and 2, (i) for BSS1, the video streaming throughput was about 32 Mbps, (ii) for BSS2, the video streaming throughput was about 32 Mbps, (iii) for BSS3, the video streaming throughput was about 25 Mbps, and (iv) for BSS4, the video streaming throughput was about 24 Mbps. For two pair C-TDMA between BSS 1 and 2 and between BSS 3 and 4, (i) for BSS1, the video streaming throughput was about 30 Mbps, (ii) for BSS2, the video streaming throughput was about 30 Mbps, (iii) for BSS3, the video streaming throughput was about 30 Mbps, and (iv) for BSS4, the video streaming throughput was about 30 Mbps.

Therefore, the use of C-TDMA improves the throughput performance for video streaming, as TCP is sensitive to latency performance, obtaining a gain in the range 10-20%.

### Example 1B: Repeater Simulation

C-TDMA was tested using a repeater (extended service set (ESS)) scenario in which there was coordination between two in-home AP devices from the same network (ESS) and sharing the same channel.

The ESS includes a gateway (GW) 1510 and repeater (R) 1520 which were connected through a wireless backhaul 1530. The repeater 1520 included a non-AP STA and AP devices which were internally bridged using the same radio. Each AP had 5 associated STAs. The OBSS STAs are in PD and ED range. The GW 1510 and repeater 1520 are in ED range using a wireless backhaul link 1530. There are two possible coordination scenarios: (1) uncoordinated and (2) GW/R coordinated (e.g., both do C-TDMA). The data frames PHY/MAC link configuration for associated STAs is SU 80 MHz/1SS/MCS:11.

The traffic generation used various services. The gateway had various associated STAs. First, STA1 used video conference (DL, UL 3 Mbps, 250 B length) using UDP and VI_AC. Second, STA2 used video streaming at 4K UHD H264 (DL 32 Mbps, 1500 B length) using closed loop TCP and VI_AC. Third, STA3 used gaming at DL/UL 140 kbps, periodicity 7 ms, 110 B length using UDP and VO_AC. Fourth, STA4 used cloud file sync (DL/UL 10 Mbps) using closed-loop TCP and BE_AC. Fifth, STA5 used a camera (UL 2 Mbps, 1450 B length) using UDP and VI_AC.

The repeater had various associated STAs. First, STA6 used video conference (DL, UL 3 Mbps, 250 B length) using UDP and VI_AC. Second, STA7 used video streaming at 4K UHD H264 (DL 32 Mbps, 1500 B length) using closed loop TCP and VI_AC. Third, STA8 used video streaming at 4K UHD H264 (DL 32 Mbps, 1500 B length) using closed loop TCP and VI_AC. Fourth, STA9 used gaming at DL/UL 140 kbps, periodicity 7 ms, 110 B length using UDP and VO_AC. Fifth, STA10 used a camera (UL 2 Mbps, 1450 B length) using UDP and VI_AC.

The repeater simulations used five different coordination setups. First, there was no coordination between the GW and repeater (i.e., baseline). Second, C-TDMA strategy 1 was used (i.e., share the remaining TXOP length, after the sharing AP local buffers are empty (for the gained and higher ACs)). Third C-TDMA strategy 2 was used (i.e., the soft time threshold was set from higher layers (using managed networks)). For one case, there was a sharing threshold of 50/50 in which there was 50% of the TXOP length for the GW and 50% of the TXOP length for the repeater. For another case, there was a sharing threshold of 60/40 in which there was 60% of the TXOP length for the GW and 40% of the length for the repeater. For another case, there was a sharing threshold of 70/30 in which there was 70% of the TXOP length for the GW and 30% of the length for the repeater.

### Overall Simulation Results

There was no improvement for strategy 1, with few opportunities for sharing the TXOP and having additional overhead, the network latency got worse with respect to the uncoordinated setup. The best improvements were for the sharing thresholds of 50/50 and 60/40, improving the data flow along the repeater. Reducing the shared TXOP length on the repeater side increased the latency, having less time to schedule its associated STAs. Even if the traffic load is higher in the GW side, the number of associated STAs in both sides is the same.

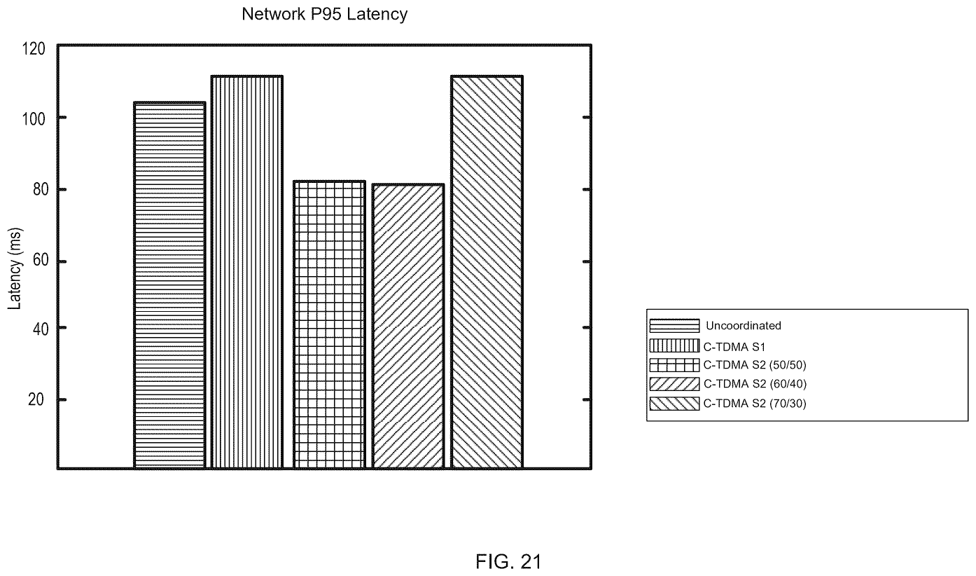

As illustrated in FIG. 21, the network P95 latency is charted for the different cases. For the uncoordinated case, the network P95 latency was about 105 ms. For the C-TDMA strategy 1 (S1) case, the network P95 latency was about 110 ms. For the C-TDMA strategy 2 (S2) 50/50 case, the network P95 latency was about 80 ms. For the C-TDMA S2 60/40 case, the network P95 latency was about 80 ms. For the C-TDMA S2 70/30 case, the network P95 latency was about 110 ms.

### Gaming Results

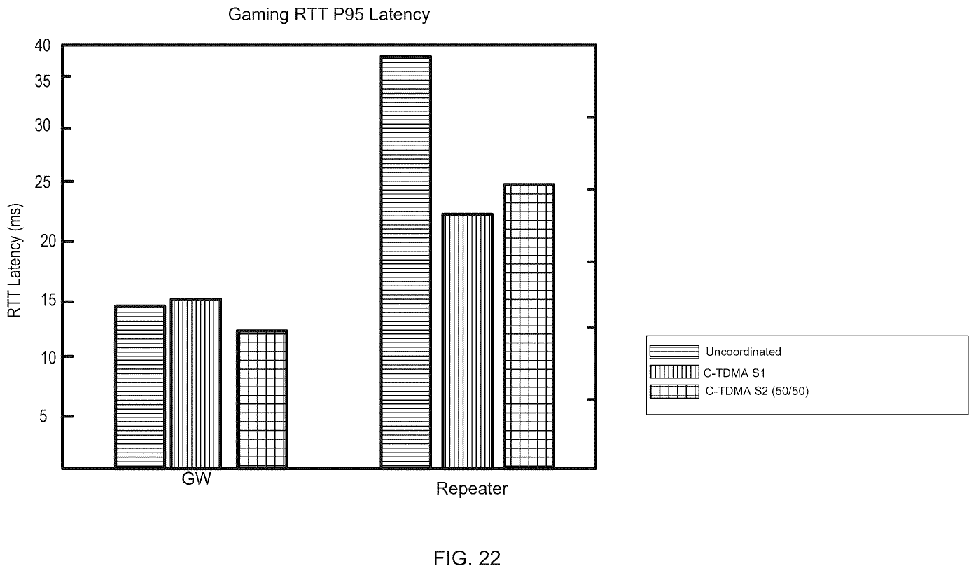

The gaming results are provided in FIG. 22. For the GW, the results were similar among the different cases. For the uncoordinated case, the RTT latency was about 15 ms. For C-TDMA S1, the RTT latency was about 15 ms. For C-TDMA S2 50/50, the RTT latency was about 13 ms. For the repeater, the results differed among the different cases. For the uncoordinated case, the RTT latency was about 38 ms. For C-TDMA S1, the RTT latency was about 25 ms. For C-TDMA S2 50/50, the RTT latency was about 27 ms. Therefore, the gaming latency improved in the repeater side for both C-TDMA strategies. As the traffic load for gaming was low, the gained VO_AC TXOP had enough length for sharing in both BSSs. The GW side performance showed little variation; the main contribution of C-TDMA was the improvement for the repeater.

### Video Conference Results

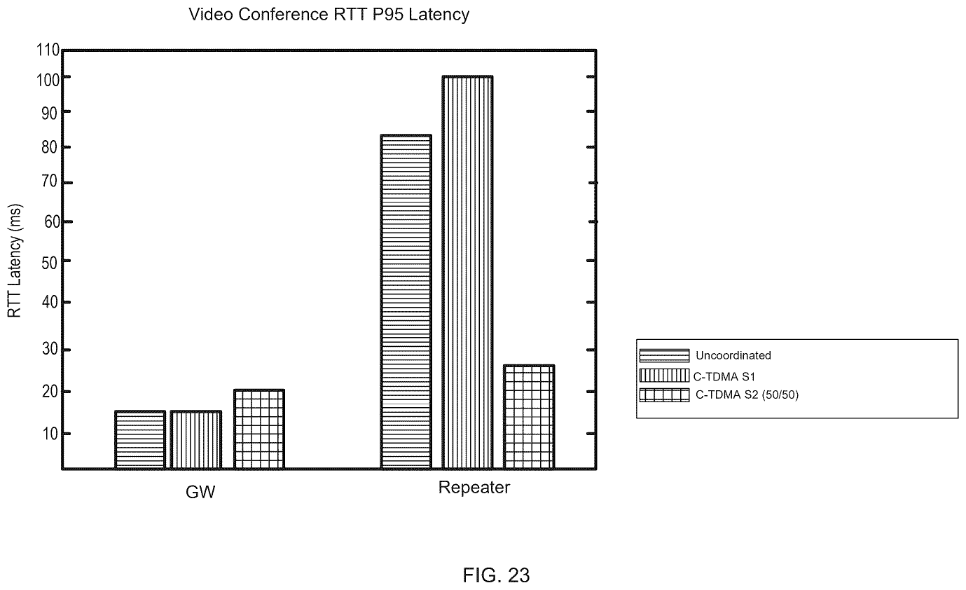

The video conference results are provided in FIG. 23. For the GW, the results were similar among the different cases. For the uncoordinated case, the RTT P95 latency was about 15 ms. For C-TDMA S1, the RTT P95 latency was about 15 ms. For C-TDMA S2 50/50, the RTT P95 latency was about 20 ms. For the repeater, the results differed among the different cases. For the uncoordinated case, the RTT P95 latency was about 90 ms. For C-TDMA S1, the RTT P95 latency was about 105 ms. For C-TDMA S2 50/50, the RTT P95 latency was about 30 ms. For C-TDMA S2, the video conference latency was improved by 65%, as the coordination enhanced the data flow between the GW and repeater. The GW side performance showed little variation, the main contribution of C-TDMA was the improvement for the repeater.

### Video Streaming Results

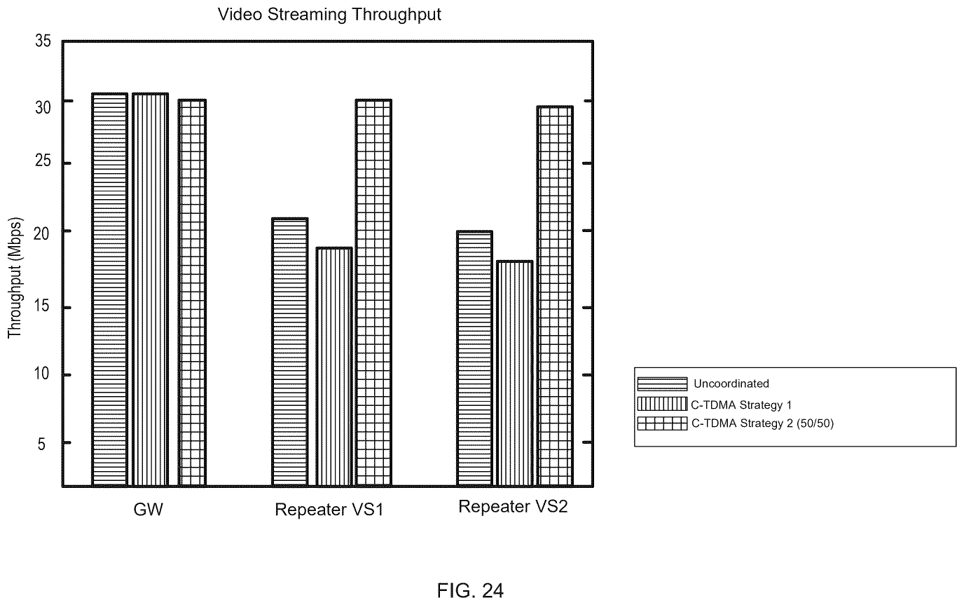

The video streaming results are provided in FIG. 24. For the GW, the results were similar among the different cases. For the uncoordinated case, the video streaming throughput was about 32 Mbps. For C-TDMA S1, the video streaming throughput was about 32 Mbps. For C-TDMA S2 50/50, the video streaming throughput was about 32 Mbps.

For the repeater VS1, the results differed among the different cases. For the uncoordinated case, the video streaming throughput was about 23 Mbps. For C-TDMA S1, the video streaming throughput was about 20 Mbps. For C-TDMA S2 50/50, the video streaming throughput was about 32 Mbps.

For the repeater VS2, the results differed among the different cases. For the uncoordinated case, the video streaming throughput was about 22 Mbps. For C-TDMA S1, the video streaming throughput was about 18 Mbps. For C-TDMA S2 50/50, the video streaming throughput was about 31 Mbps.

Therefore, the use of C-TDMA S2 improved the latency in video streaming service, and consequently the throughput was improved, as TCP is sensitive to the RTT latency. The GW performance showed little variation; the main contribution of C-TDMA was the improvement for the repeater.

### Example 1C: Summary

C-TDMA improved the performance in those latency-sensitive flows/services already configured with their corresponding high-priority ACs; otherwise the improvement was limited. C-TDMA redistributed the time resources, giving more chances to specific already protected services, but did not create additional resources. C-TDMA provided better chances to give the channel to another BSS, especially in those highly congested scenarios with many contending STAs. Coordinated APs can generate the same number of TXOPs, with the same priority, to have balanced cooperation; otherwise only one network will take advantage of C-TDMA. Most advantages of C-TDMA were seen in repeater scenarios, improving the performance in terms of throughput and RTT latency of the repeater network for the protected services.

Simulation results for coordinated TDMA mechanism were provided, focusing on the performance improvement of the latency sensitive services. The highly congested scenario under an OBSS environment and the repeater scenario was covered. In both cases, C-TDMA increased the number of transmission opportunities for those services configured with high priority AC, which under congestion conditions may have limited advantage. In the repeater case, the coordination between the two APs improved the data flow through the wireless backhaul.

### Example 2A: Repeater Simulation

C-TDMA was deployed in a repeater scenario—coordination between two in-home AP devices from the same network (ESS) and sharing the same channel.

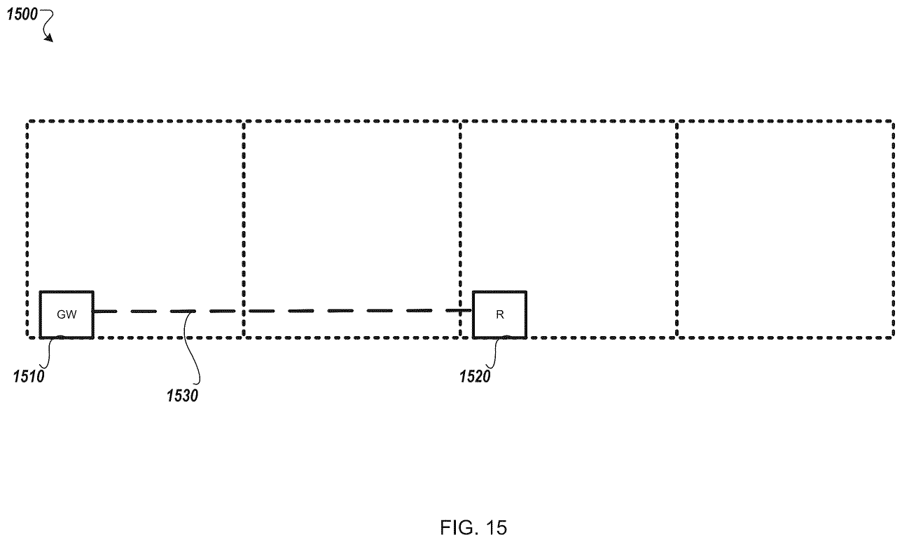

The ESS included a GW and repeater connected through a wireless backhaul. The repeater included non-AP STA and AP devices, internally bridged using the same radio. The repeater had 5 associated STAs, creating an unbalanced situation between GW and repeater. OBSS STAs were in PD and ED range and BSS STs were in ED range. The GW and repeater were in ED range. There were two possible coordination scenarios: uncoordinated and GW/R coordinated (both do C-TDMA). PHY/MAC configuration for data frames was SU 80 MHz/1SS/MCS:11 for creating overloading situations. The repeater simulation was setup was shown in FIG. 15.

### Traffic Generation

The gateway associated STAs included the STA repeater via the backhaul link. The repeater associated STAs included: (1) STA6—video conference (DL/UL 3 Mbps, 250 B length using UDP and VI_AC, (2) STA 7—video streaming (4K UHD H264 (DL 64 Mbps) using closed loop TCP and VI_AC, (3) STA8—video streaming (4K UHD H264 (DL 64 Mbps) using closed loop TCP and VI_AC, (4) STA9—gaming (DL/UL 140 kbps, periodicity 7 ms, 110 B length) using UDP and VO_AC, and (5) STA10—camera (UL 2 Mbps, 1450 B length) using UDP and VI_AC. The backhaul link used STA6-10 services. The STAs generated UL traffic using TB and enhanced distributed channel access (EDCA) mechanisms.

### Simulation Strategies

There were four different approaches to decide the shared TXOP length. Strategy 1 was to share the remaining TXOP length after the sharing AP local buffers were empty (for the gained and higher ACs). The TXOP ended after the shared AP finished, which might send a CF-End frame for early termination.

Strategy 2 was a soft time threshold sent from higher layers (e.g., managed networks). The sharing AP might start sharing the TXOP before the time threshold if there is no more data to share, for the gained and higher ACs, in its BSS (case A). The sharing AP may delay sharing the TXOP if there is an ongoing data exchange that exceeds the time threshold (case B). A flexible maximum time length was defined that the sharing APO can use for transferring data, established by an external arbiter, while the rest were used by the shared AP. The TXOP ended after the shared AP finished, which might send a CF-End frame for early termination. This strategy is illustrated in FIG. 16.

Strategy 3 was to dynamically calculate the time threshold based on the buffer status knowledge. Based on the current knowledge of the buffer's status for the gained AC, each AP calculated the needed TXOP length. The sharing AP sent its calculation in the initial control frame (ICF) and the shared AP included its calculation in the initial control response (ICR). The sharing AP prioritized its own functionality when the sum of both calculations exceeded the TXOP limit. Once the pre-negotiation concluded, strategy 2 was followed.

Strategy 4 was to dynamically calculate the time threshold based on the buffer status knowledge and traffic prediction. In addition to the estimation from strategy 3, the APs estimated additional time based on the prediction of future incoming data frames along the TXOP having a more accurate calculation. Based on the previous calculation, strategy 3 was followed.

In summary, S1 worked in standalone mode while S2-S4 used pre-negotiation or management from higher layers. Each strategy may be selected depending on the nature of the network.

The repeater simulations used five different coordination setups. First, no coordination between GW and repeater (i.e., baseline). Second, C-TDMA strategy 1 (S1). Third, C-TDMA strategy 2 (S2) having a sharing threshold of 50/50 (50% of TXOP length for the GW and 50% TXOP length for the repeater) or a sharing threshold of 40/60 (having a TXOP length of 40% for the GW and 60% TXOP length for the repeater). Fourth, C-TDMA strategy 3 (S3). Fifth, C-TDMA strategy 4 (S4).

### Overall Simulation Results

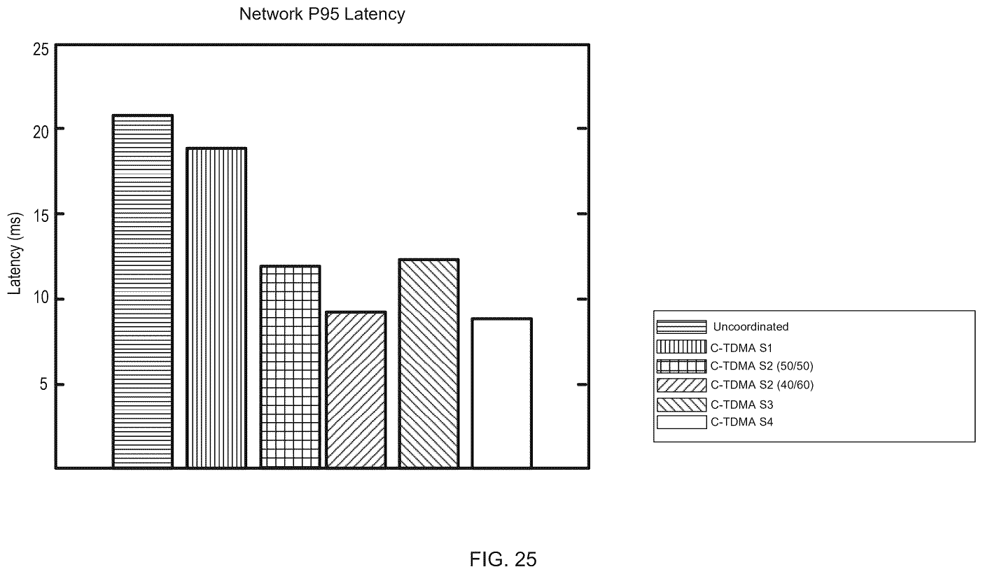

As illustrated in FIG. 25, for the uncoordinated case, the network P95 latency was about 21 ms. For C-TDMA S1, the network P95 latency was about 19 ms. For C-TDMA S2 50/50, the network P95 latency was about 13 ms. For C-TDMA 40/60, the network P95 latency was about 8 ms. For C-TDMA S3, the network P95 latency was about 12 ms. For C-TDMA S4, the network P95 latency was about 8 ms.

Therefore, C-TDMA based on S2/S3/S4 improved the network latency tail by 69% to 136%, whereas S1 had a minor impact on the performance. C-TDMA S4 based on dynamic TXOP calculation obtained the best performance, obtaining a similar result for the unbalanced tuning of S2 (40/60).

### Gaming Results

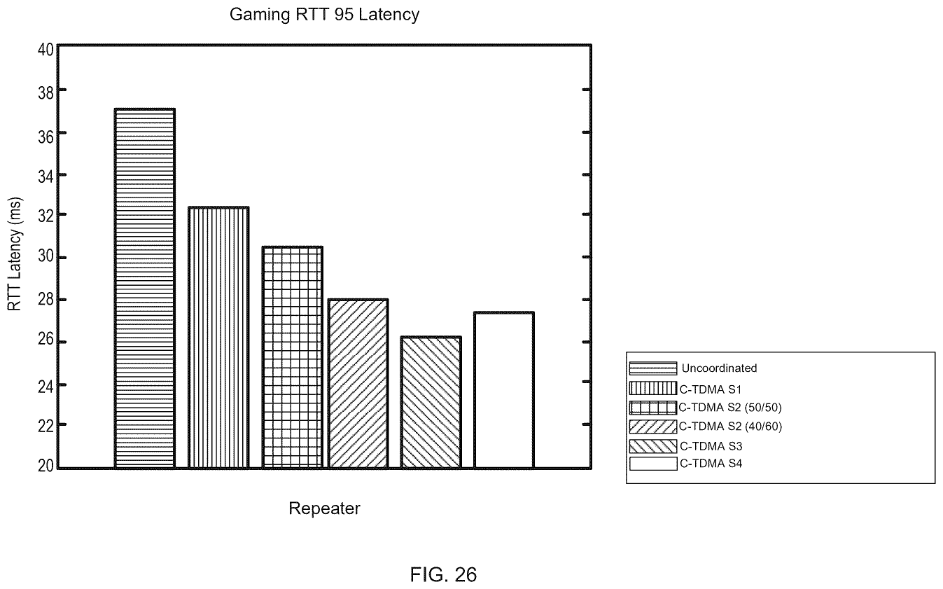

As illustrated in FIG. 26, for the uncoordinated case, the gaming RTT P95 latency was about 37 ms. For C-TDMA S1, the gaming RTT P95 latency was about 32 ms. For C-TDMA S2 50/50, the gaming RTT P95 latency was about 30 ms. For C-TDMA 40/60, the gaming RTT P95 latency was about 28 ms. For C-TDMA S3, the gaming RTT P95 latency was about 26 ms. For C-TDMA S4, the gaming RTT P95 latency was about 28 ms.

Therefore, C-TDMA based on unbalanced S2 and S3/S4 improved the gaming latency tail, whereas S1 had a low impact on the performance, and balanced S2 was less effective due to the network topology characteristics.

### Video Conference Results

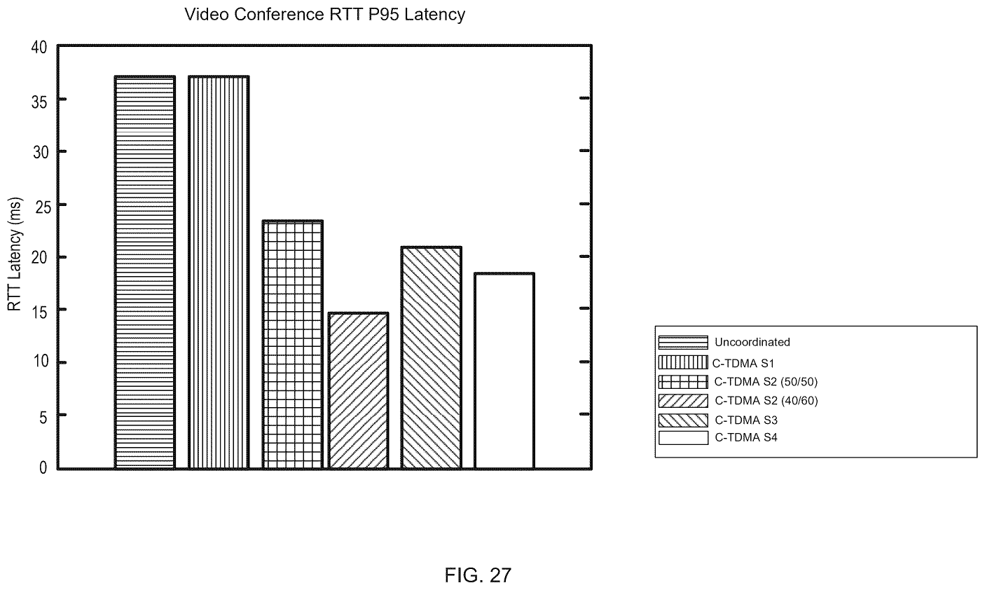

As illustrated in FIG. 27, for the uncoordinated case, the video conference RTT P95 latency was about 37 ms. For C-TDMA S1, the video conference RTT P95 latency was about 37 ms. For C-TDMA S2 50/50, the video conference RTT P95 latency was about 24 ms. For C-TDMA 40/60, the video conference RTT P95 latency was about 15 ms. For C-TDMA S3, the video conference RTT P95 latency was about 22 ms. For C-TDMA S4, the video conference RTT P95 latency was about 20 ms.

Therefore, C-TDMA based on unbalanced S2 and S3/S4 improved the video conference latency tail, whereas S1 had a low impact on the performance, and balanced S2 was less effective due to the network topology characteristics.

### Video Streaming Results

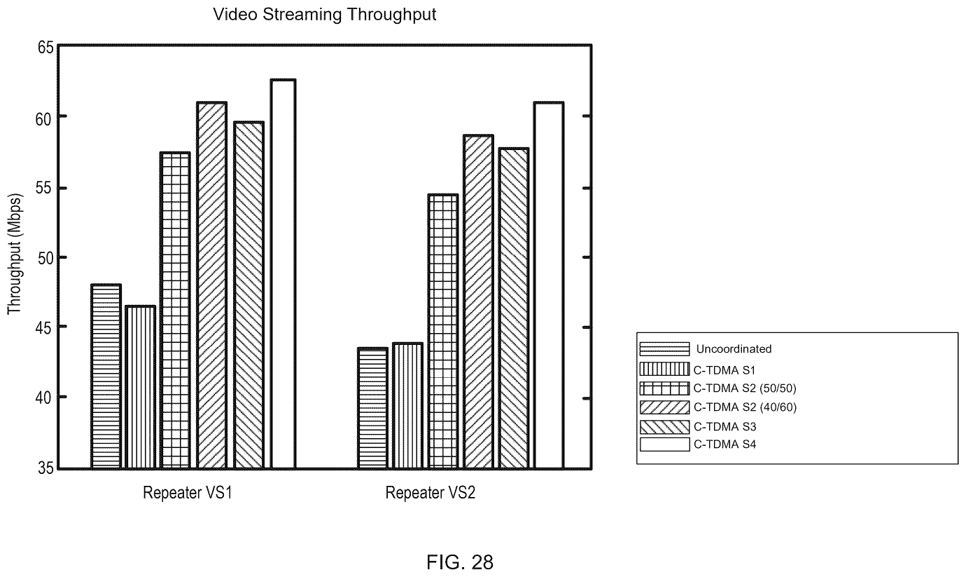

As illustrated in FIG. 28 for repeater VS1, for the uncoordinated case, the video streaming throughput was about 47 Mbps. For C-TDMA S1, the video streaming throughput was about 46 Mbps. For C-TDMA S2 50/50, the video streaming throughput was about 57 Mbps. For C-TDMA 40/60, the video streaming throughput was about 62 Mbps. For C-TDMA S3, the video streaming throughput was about 60 Mbps. For C-TDMA S4, the video streaming throughput was about 63 Mbps.

For repeater VS2, for the uncoordinated case, the video streaming throughput was about 44 Mbps. For C-TDMA S1, the video streaming throughput was about 44 Mbps. For C-TDMA S2 50/50, the video streaming throughput was about 55 Mbps. For C-TDMA 40/60, the video streaming throughput was about 58 Mbps. For C-TDMA S3, the video streaming throughput was about 57 Mbps. For C-TDMA S4, the video streaming throughput was about 61 Mbps.

Therefore, regardless of video streaming throughput, the best performance was obtained for unbalanced S2 and S4. The performance difference between balanced S2 and S4 was due to the nature of the unbalanced network topology, whereas S4 adjusts the needs dynamically. Even in the unbalanced network situation, C-TDMA S2 still performed well as both BSSs were correlated.

### Example 2B: OBSS Simulation

C-TDMA was deployed in an OBSS scenario—coordination between two in-home AP devices from the same network (ESS) and sharing the same channel.

Three OBSS scenarios were used under different conditions.

In scenario 1, the OBSS was balanced. For BSSs shared the same channel—having a balanced traffic load and number of associated STAs between the BSSs. Coordination is enabled between BSS1 and BSS2, while BSS 3/4 remained as an uncoordinated OBSS.

In scenario 2, the OBSS was unbalanced. Two BSSs shared the same channel having unbalanced traffic load and number of associated STAs between the two BSSs. Similar network traffic generation and priority classification in both BSSs. Both APs generated TXOPs on commonly assigned ACs, creating opportunities on both sides, having an effective cooperation.

In scenario 3, three BSSs shared the same channel. Coordination was possible between BSS1 and BSS2, while BSS3 remained an as OBSS. There was an unbalanced traffic load and number of associated STAs between BSS1 and BSS2. Different network traffic generation and priority assignment was in each BSS-both APS did not generate TXOPs on commonly assigned ACs which created fewer cooperation opportunities.

The data frames PHY/MAC link configuration for associated STAs was SU 80MHz/1SS/MCS:11 for creating over loading situations. The OBSS STAs were in PD and ED range. The BSS STAs were in ED range.

### Traffic Generation

For scenario 1, there were four BSSs, two of which may be coordinated. Each BSS had the following data services: (1) STA1—video conference (DL/UL 3 Mbps, 250 B length using UDP and VI_AC, (2) STA 2—video streaming (4K UHD H264 (DL 32 Mbps, 1500 B length) using closed loop TCP and VI_AC, (3) STA3—gaming (DL/UL 140 kbps, periodicity 7 ms, 110 B length) using UDP and VO_AC, (4) STA4—cloud file sync (DL/UL 10 Mbps, 1500 B length using closed loop TCP, BE_AC, and (5) STA5—camera (UL 2 Mbps, 1450 B length) using UDP and VI_AC.

For scenario 2, two BSSs may be coordinated. There was unbalanced traffic and associated STAs with respect to each BSS. BSS1 had 9 associated STAs including: (i) 2× video conference (DL/UL 3 Mbps, 250 B length using UDP and VI_AC, (ii) 2× video streaming (4K UHD H264 (DL 64 Mbps, 1500 B length) using closed loop TCP and VI_AC, (iii) 2× gaming (DL/UL 140 kbps, periodicity 7 ms, 110 B length) using UDP and VO_AC), (iv) 2× cloud file sync (DL/UL 10 Mbps, 1500 B length using closed loop TCP, BE_AC), and (v) 1× camera (UL 2 Mbps, 1450 B length) using UDP and VI_AC.

For scenario 2, BSS 2 had 5 associated STAs including: (i) 1× video conference (DL/UL 3 Mbps, 250 B length using UDP and VI_AC, (ii) 1× video streaming (4K UHD H264 (DL 64 Mbps, 1500 B length) using closed loop TCP and VI_AC, (iii) 1× gaming (DL/UL 140 kbps, periodicity 7 ms, 110 B length) using UDP and VO_AC), (iv) 1× cloud file sync (DL/UL 10 Mbps, 1500 B length using closed loop TCP, BE_AC), and (v) 1× camera (UL 2 Mbps, 1450 B length) using UDP and VI_AC.

For scenario 3, BSS1 and BSS2 may be coordinated (i.e., C-TDMA) and a third OBSS (BSS3). BSS1 was associated with 7 STAs including: (i) 2× video conference (DL/UL 3 Mbps, 250 B length using UDP and VI_AC, (ii) 2× video streaming (4K UHD H264 (DL 64 Mbps, 1500 B length) using closed loop TCP and VI_AC, (iii) 1× gaming (DL/UL 140 kbps, periodicity 7 ms, 110 B length) using UDP and VO_AC), (iv) 1× cloud file sync (DL/UL 10 Mbps, 1500 B length using closed loop TCP, BE_AC), and (v) 1× camera (UL 2 Mbps, 1450 B length) using UDP and VI_AC.

For scenario 3, BSS2 was associated with 3 STAs including: (i) 1× gaming (DL/UL 140 kbps, periodicity 7 ms, 110 B length) using UDP and VO_AC), (ii) 1× cloud file sync (DL/UL 10 Mbps, 1500 B length using closed loop TCP, BE_AC), and (iii) 1× camera (UL 2 Mbps, 1450 B length) using UDP and VI_AC.

For scenario 3, BSS3 was associated with 5 STAs including: (i) 1× video conference (DL/UL 3 Mbps, 250 B length using UDP and VI_AC, (ii) 1× video streaming (4K UHD H264 (DL 64 Mbps, 1500 B length) using closed loop TCP and VI_AC, (iii) 1× gaming (DL/UL 140 kbps, periodicity 7 ms, 110 B length) using UDP and VO_AC), (iv) 1× cloud file sync (DL/UL 10 Mbps, 1500 B length using closed loop TCP, BE_AC), and (v) 1× camera (UL 2 Mbps, 1450 B length) using UDP and VI_AC.

### Simulation Strategies

There were four different approaches to decide the shared TXOP length. Strategy 1 was to share the remaining TXOP length after the sharing AP local buffers were empty (for the gained and higher ACs). The TXOP ended after the shared AP finished, which might send a CF-End frame for early termination.

Strategy 2 was a soft time threshold sent from higher layers (e.g., managed networks). The sharing AP might start sharing the TXOP before the time threshold if there is no more data to share, for the gained and higher ACs, in its BSS (case A). The sharing AP may delay sharing the TXOP if there is an ongoing data exchange that exceeds the time threshold (case B). A flexible maximum time length was defined that the sharing APO can use for transferring data, established by an external arbiter, while the rest were used by the shared AP. The TXOP ended after the shared AP finished, which might send a CF-End frame for early termination. This strategy is illustrated in FIG. 16.

Strategy 3 was to dynamically calculate the time threshold based on the buffer status knowledge. Based on the current knowledge of the buffer's status for the gained AC, each AP calculated the needed TXOP length. The sharing AP sent its calculation in the initial control frame (ICF) and the shared AP included its calculation in the initial control response (ICR). The sharing AP prioritized its own functionality when the sum of both calculations exceeded the TXOP limit. Once the pre-negotiation concluded, strategy 2 was followed.

Strategy 4 was to dynamically calculate the time threshold based on the buffer status knowledge and traffic prediction. In addition to the estimation from strategy 3, the APs estimated additional time based on the prediction of future incoming data frames along the TXOP having a more accurate calculation. Based on the previous calculation, strategy 3 was followed.

In summary, S1 worked in standalone mode while S2-S4 used pre-negotiation or management from higher layers. Each strategy may be selected depending on the nature of the network.

### Scenario 1—Balanced OBSS

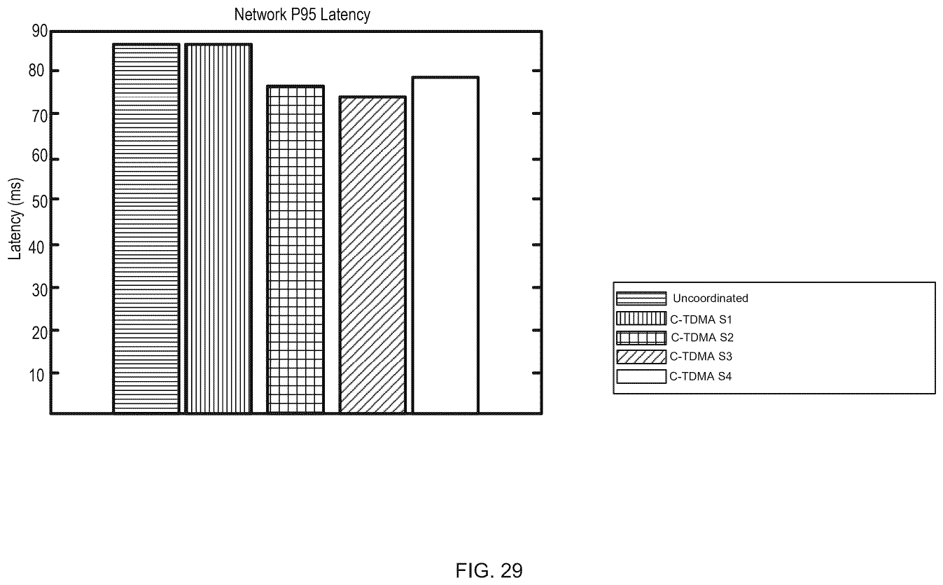

For scenario 1 (i.e., a balanced OBSS), as illustrated in FIG. 29, there was a slight reduction of the network tail latency for all the strategies (except for S1) because BSS3and BSS4 remain uncoordinated. For the uncoordinated case, the network P95 latency was about 88 ms. For the C-TDMA S1 case, the network P95 latency was about 88 ms. For the C-TDMA S2 case, the network P95 latency was about 75 ms. For the C-TDMA S3 case, the network P95 latency was about 72 ms. For the C-TDMA S4 case, the network P95 latency was about 80 ms.

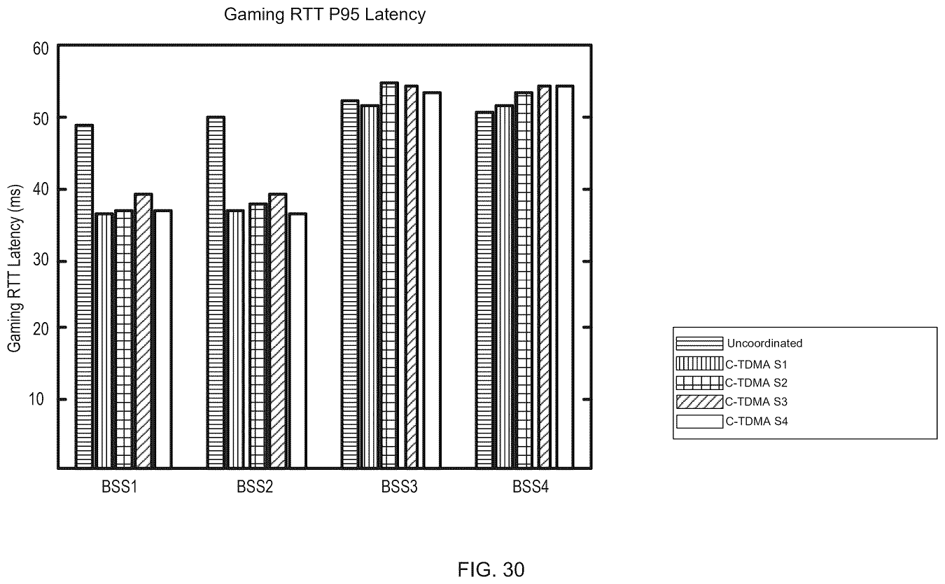

As illustrated in FIG. 30, gaming service showed similar performance for any of the C-TDMA strategies, mainly because short-duration data frames were sent, having no problems for sharing time from a gained TXOP.

For BSS1, for the uncoordinated case, the gaming RTT P95 latency was about 48 ms. For the C-TDMA S1 case, the gaming RTT P95 latency was about 35 ms. For the C-TDMA S2 case, the gaming RTT P95 latency was about 38 ms. For the C-TDMA S3 case, the gaming RTT P95 latency was about 40 ms. For the C-TDMA S4 case, the gaming RTT P95 latency was about 38 ms.

For BSS2, for the uncoordinated case, the gaming RTT P95 latency was about 50 ms. For the C-TDMA S1 case, the gaming RTT P95 latency was about 35 ms. For the C-TDMA S2 case, the gaming RTT P95 latency was about 38 ms. For the C-TDMA S3 case, the gaming RTT P95 latency was about 40 ms. For the C-TDMA S4 case, the gaming RTT P95 latency was about 38 ms.

For BSS3, for the uncoordinated case, the gaming RTT P95 latency was about 52 ms. For the C-TDMA S1 case, the gaming RTT P95 latency was about 51 ms. For the C-TDMA S2 case, the gaming RTT P95 latency was about 55 ms. For the C-TDMA S3 case, the gaming RTT P95 latency was about 54 ms. For the C-TDMA S4 case, the gaming RTT P95 latency was about 52 ms.

For BSS4, for the uncoordinated case, the gaming RTT P95 latency was about 50 ms. For the C-TDMA S1 case, the gaming RTT P95 latency was about 51 ms. For the C-TDMA S2 case, the gaming RTT P95 latency was about 53 ms. For the C-TDMA S3 case, the gaming RTT P95 latency was about 54 ms. For the C-TDMA S4 case, the gaming RTT P95 latency was about 54 ms.

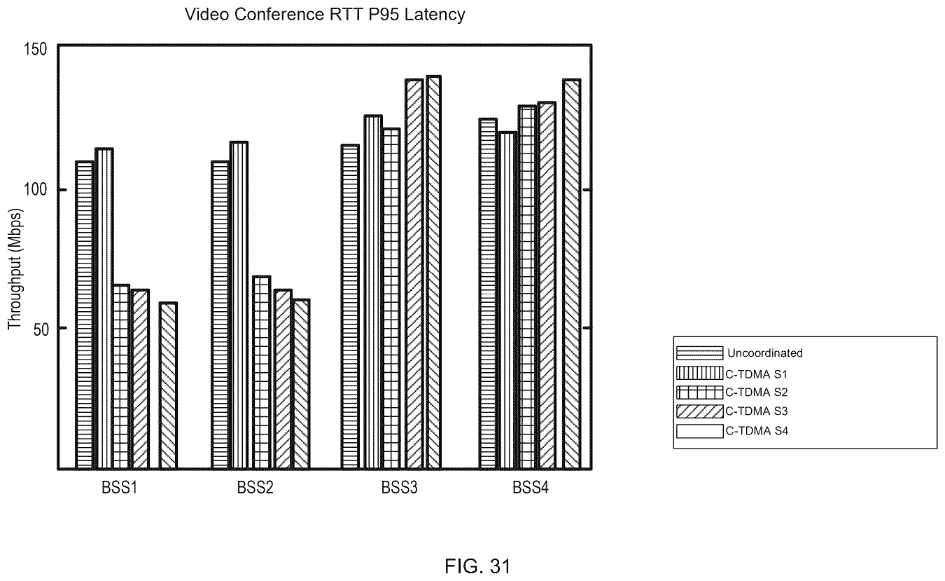

As illustrated in FIG. 31, video conference showed similar behavior, except for S1; same performance is reported by the other strategies, mainly due to the fact that both networks were balanced and shared similar traffic.

For BSS1, for the uncoordinated case, the video conference RTT P95 latency was about 110 ms. For the C-TDMA S1 case, the video conference RTT P95 latency was about 115 ms. For the C-TDMA S2 case, the video conference RTT P95 latency was about 60 ms. For the C-TDMA S3 case, the video conference RTT P95 latency was about 60 ms. For the C-TDMA S4 case, the video conference RTT P95 latency was about 55 ms.

For BSS2, for the uncoordinated case, the video conference RTT P95 latency was about 110 ms. For the C-TDMA S1 case, the video conference RTT P95 latency was about 115 ms. For the C-TDMA S2 case, the video conference RTT P95 latency was about 65 ms. For the C-TDMA S3 case, the video conference RTT P95 latency was about 60 ms. For the C-TDMA S4 case, the video conference RTT P95 latency was about 55 ms.

For BSS3, for the uncoordinated case, the video conference RTT P95 latency was about 110 ms. For the C-TDMA S1 case, the video conference RTT P95 latency was about 120 ms. For the C-TDMA S2 case, the video conference RTT P95 latency was about 115 ms. For the C-TDMA S3 case, the video conference RTT P95 latency was about 140 ms. For the C-TDMA S4 case, the video conference RTT P95 latency was about 140 ms.

For BSS4, for the uncoordinated case, the video conference RTT P95 latency was about 120 ms. For the C-TDMA S1 case, the video conference RTT P95 latency was about 115 ms. For the C-TDMA S2 case, the video conference RTT P95 latency was about 125 ms. For the C-TDMA S3 case, the video conference RTT P95 latency was about 130 ms. For the C-TDMA S4 case, the video conference RTT P95 latency was about 140 ms.

For this video conferencing setup, managed threshold and dynamic threshold calculation converged to same result, being equivalent strategies under this balanced situation.

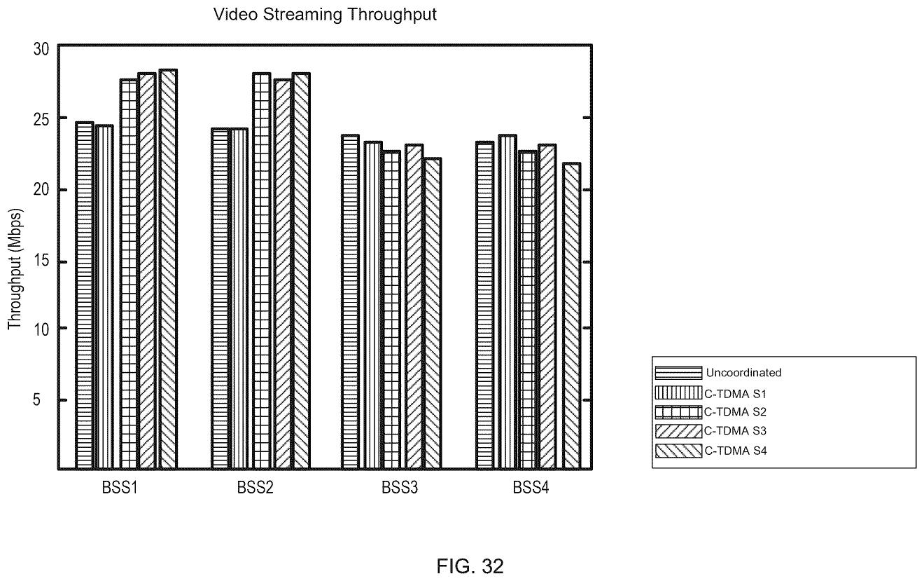

As illustrated in FIG. 32, video streaming showed similar behavior, except for S1; same performance was reported by the other strategies, mainly due to the fact that both networks were balanced and shared similar traffic.

For BSS1, for the uncoordinated case, the video streaming throughput was about 25 Mbps. For the C-TDMA S1 case, the video streaming throughput was about 25 Mbps. For the C-TDMA S2 case, the video streaming throughput was about 27 Mbps. For the C-TDMA S3 case, the video streaming throughput was about 28 Mbps. For the C-TDMA S4 case, the video streaming throughput was about 28 Mbps.

For BSS2, for the uncoordinated case, the video streaming throughput was about 25 Mbps. For the C-TDMA S1 case, the video streaming throughput was about 25 Mbps. For the C-TDMA S2 case, the video streaming throughput was about 27 Mbps. For the C-TDMA S3 case, the video streaming throughput was about 27 Mbps. For the C-TDMA S4 case, the video streaming throughput was about 27 Mbps.

For BSS3, for the uncoordinated case, the video streaming throughput was about 25 Mbps. For the C-TDMA S1 case, the video streaming throughput was about 25 Mbps. For the C-TDMA S2 case, the video streaming throughput was about 24 Mbps. For the C-TDMA S3 case, the video streaming throughput was about 25 Mbps. For the C-TDMA S4 case, the video streaming throughput was about 24 Mbps.

For BSS4, for the uncoordinated case, the video streaming throughput was about 25 Mbps. For the C-TDMA S1 case, the video streaming throughput was about 25 Mbps. For the C-TDMA S2 case, the video streaming throughput was about 24 Mbps. For the C-TDMA S3 case, the video streaming throughput was about 25 Mbps. For the C-TDMA S4 case, the video streaming throughput was about 23 Mbps.

For this video streaming setup, managed threshold and dynamic threshold calculation converged to same result, being equivalent strategies under this balanced situation.

### Scenario 2: Unbalanced OBSS

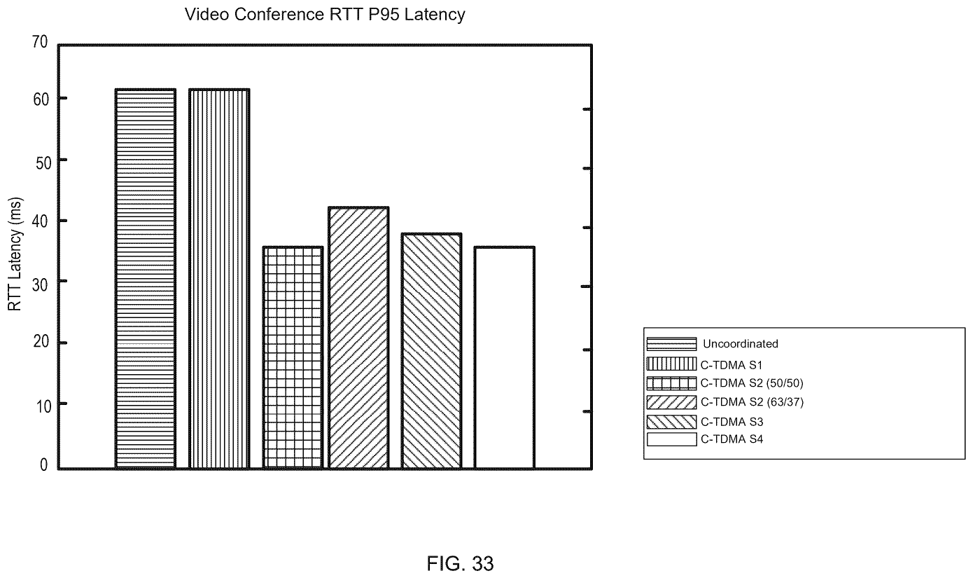

For scenario 2 (i.e., an unbalanced OBSS), as illustrated in FIG. 33, there was an overall reduction of the network tail latency for all the strategies (except for S1). For the uncoordinated case, the network P95 latency was about 62 ms. For the C-TDMA S1 case, the network P95 latency was about 62 ms. For the C-TDMA S2 50/50 case, the network P95 latency was about 37 ms. For the C-TDMA S2 63/37 case, the network P95 latency was about 42 ms. For the C-TDMA S3 case, the network P95 latency was about 38 ms. For the C-TDMA S4 case, the network P95 latency was about 37 ms.

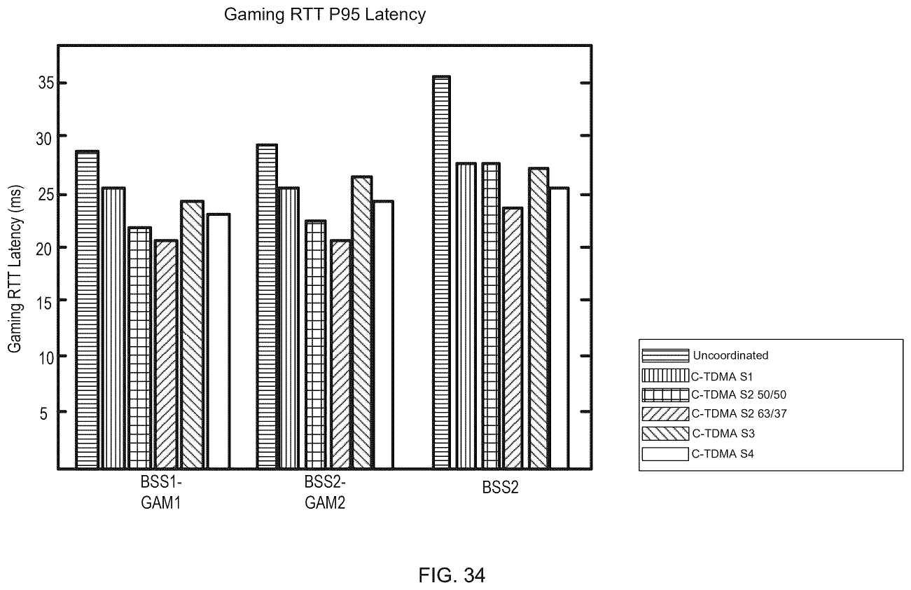

As illustrated in FIG. 34, gaming service showed similar performance for any of the C-TDMA strategies, mainly because short-duration data frames were sent, having no problems for sharing time from a gained TXOP.

For BSS1-GAM1, for the uncoordinated case, the gaming RTT P95 latency was about 29 ms. For the C-TDMA S1 case, the gaming RTT P95 latency was about 25 ms. For the C-TDMA S2 50/50 case, the gaming RTT P95 latency was about 22 ms. For the C-TDMA S2 63/37 case, the gaming RTT P95 latency was about 20 ms. For the C-TDMA S3 case, the gaming RTT P95 latency was about 25 ms. For the C-TDMA S4 case, the gaming RTT P95 latency was about 22 ms.

For BSS1-GAM2, for the uncoordinated case, the gaming RTT P95 latency was about 29 ms. For the C-TDMA S1 case, the gaming RTT P95 latency was about 25 ms. For the C-TDMA S2 50/50 case, the gaming RTT P95 latency was about 22 ms. For the C-TDMA S2 63/37 case, the gaming RTT P95 latency was about 20 ms. For the C-TDMA S3 case, the gaming RTT P95 latency was about 25 ms. For the C-TDMA S4 case, the gaming RTT P95 latency was about 23 ms.

For BSS2, for the uncoordinated case, the gaming RTT P95 latency was about 35 ms. For the C-TDMA S1 case, the gaming RTT P95 latency was about 26 ms. For the C-TDMA S2 50/50 case, the gaming RTT P95 latency was about 26 ms. For the C-TDMA S2 63/37 case, the gaming RTT P95 latency was about 23 ms. For the C-TDMA S3 case, the gaming RTT P95 latency was about 26 ms. For the C-TDMA S4 case, the gaming RTT P95 latency was about 25 ms.

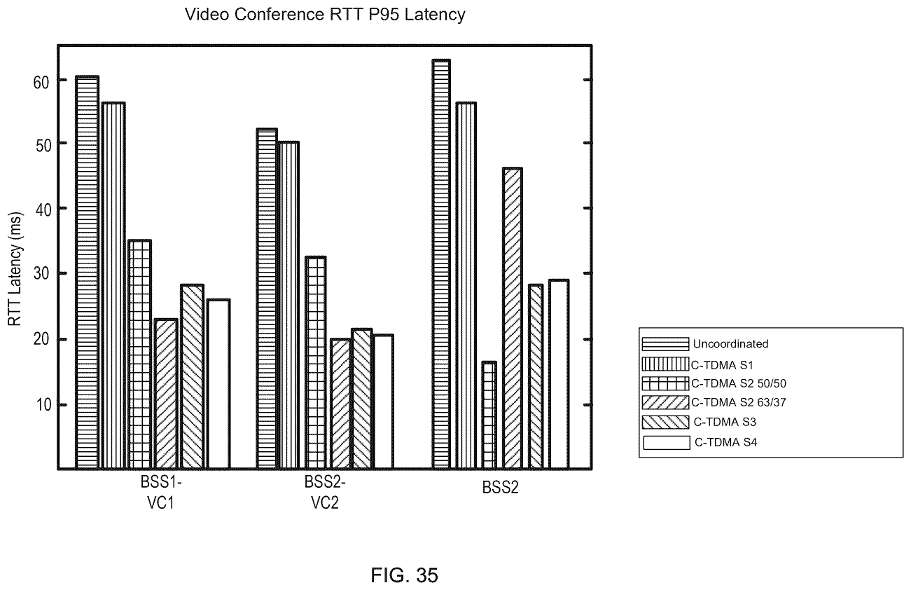

As illustrated in FIG. 35, both S2 strategies had the opposite result. In the case of balanced S2, it gave more resources to BSS2, while for the unbalanced S2 it was the contrary. Strategy S3/S4 adapted dynamically, giving an intermediate improvement, balancing the performance gain.

For BSS1-VC1, for the uncoordinated case, the video conference RTT P95 latency was about 60 ms. For the C-TDMA S1 case, the video conference RTT P95 latency was about 57 ms. For the C-TDMA S2 50/50 case, the video conference RTT P95 latency was about 35 ms. For the C-TDMA S2 63/37 case, the video conference RTT P95 latency was about 22 ms. For the C-TDMA S3 case, the video conference RTT P95 latency was about 28 ms. For the C-TDMA S4 case, the video conference RTT P95 latency was about 27 ms.

For BSS1-VC2, for the uncoordinated case, the video conference RTT P95 latency was about 53 ms. For the C-TDMA S1 case, the video conference RTT P95 latency was about 50 ms. For the C-TDMA S2 50/50 case, the video conference RTT P95 latency was about 32 ms. For the C-TDMA S2 63/37 case, the video conference RTT P95 latency was about 20 ms. For the C-TDMA S3 case, the video conference RTT P95 latency was about 21 ms. For the C-TDMA S4 case, the video conference RTT P95 latency was about 21 ms.

For BSS2, for the uncoordinated case, the video conference RTT P95 latency was about 65 ms. For the C-TDMA S1 case, the video conference RTT P95 latency was about 57 ms. For the C-TDMA S2 50/50 case, the video conference RTT P95 latency was about 17 ms. For the C-TDMA S2 63/37 case, the video conference RTT P95 latency was about 45 ms. For the C-TDMA S3 case, the video conference RTT P95 latency was about 28 ms. For the C-TDMA S4 case, the video conference RTT P95 latency was about 29 ms.

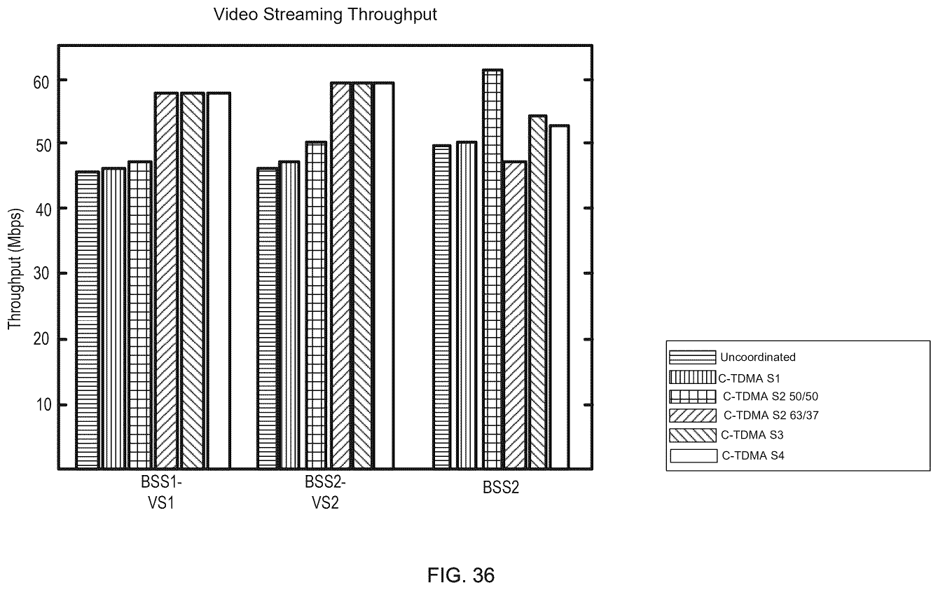

As illustrated in FIG. 36, both S2 strategies had the opposite result. In the case of balanced S2, it gave more resources to BSS2, while for the unbalanced S2 it was the contrary. Strategy S3/S4 adapted dynamically, giving an intermediate improvement, balancing the performance gain.

For BSS1-VS1, for the uncoordinated case, the video streaming throughput was about 47 Mbps. For the C-TDMA S1 case, the video streaming throughput was about 47 Mbps. For the C-TDMA S2 50/50 case, the video streaming throughput was about 48 Mbps. For the C-TDMA S2 63/37 case, the video streaming throughput was about 58 Mbps. For the C-TDMA S3 case, the video streaming throughput was about 58 Mbps. For the C-TDMA S4 case, the video streaming throughput was about 58 Mbps.

For BSS1-VS2, for the uncoordinated case, the video streaming throughput was about 49 Mbps. For the C-TDMA S1 case, the video streaming throughput was about 49 Mbps. For the C-TDMA S2 50/50 case, the video streaming throughput was about 50 Mbps. For the C-TDMA S2 63/37 case, the video streaming throughput was about 60 Mbps. For the C-TDMA S3 case, the video streaming throughput was about 60 Mbps. For the C-TDMA S4 case, the video streaming throughput was about 60 Mbps.

For BSS2, for the uncoordinated case, the video streaming throughput was about 50 Mbps. For the C-TDMA S1 case, the video streaming throughput was about 52 Mbps. For the C-TDMA S2 50/50 case, the video streaming throughput was about 62 Mbps. For the C-TDMA S2 63/37 case, the video streaming throughput was about 48 Mbps. For the C-TDMA S3 case, the video streaming throughput was about 55 Mbps. For the C-TDMA S4 case, the video streaming throughput was about 53 Mbps.

### Scenario 3: Unequal Priority

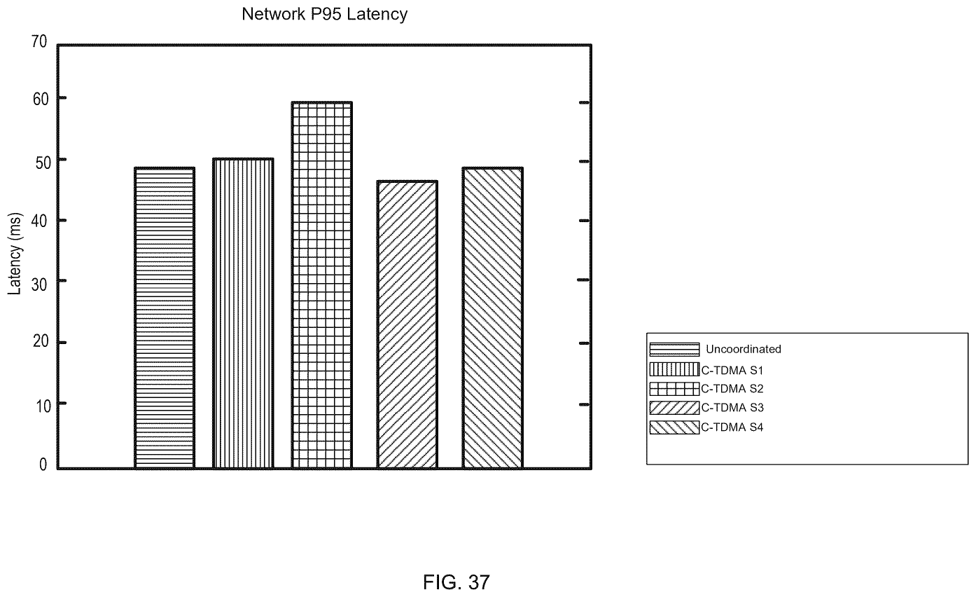

For scenario 3 (i.e., unequal priority), as illustrated in FIG. 37, the overall network latency performance was decreased, as a consequence of having large unbalanced traffic between BSS1 and BSS2, and at the same time both networks did not share the same priority AC for the main services, not allowing effective cooperation.

For the uncoordinated case, the network P95 latency was about 50 ms. For the C-TDMA S1 case, the network P95 latency was about 52 ms. For the C-TDMA S2 case, the network P95 latency was about 62 ms. For the C-TDMA S3 case, the network P95 latency was about 48 ms. For the C-TDMA S4 case, the network P95 latency was about 50 ms.

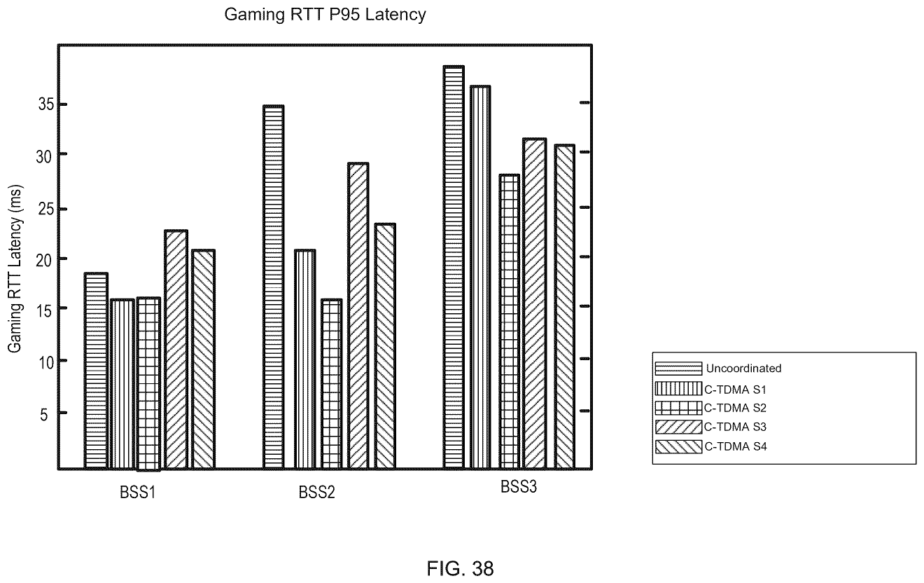

As illustrated in FIG. 38, for gaming, both networks generate VO AC traffic and may take advantage from lower priority opportunities. Because BSS2 generated fewer VI opportunities to share, there was no advantage for BSS1. On the other side, BSS2 took advantage of the BSS1 network.

For BSS1, for the uncoordinated case, the gaming RTT P95 latency was about 18 ms. For the C-TDMA S1 case, the gaming RTT P95 latency was about 16 ms. For the C-TDMA S2 case, the gaming RTT P95 latency was about 16 ms. For the C-TDMA S3 case, the gaming RTT P95 latency was about 23 ms. For the C-TDMA S4 case, the gaming RTT P95 latency was about 22 ms.

For BSS2, for the uncoordinated case, the gaming RTT P95 latency was about 35 ms. For the C-TDMA S1 case, the gaming RTT P95 latency was about 22 ms. For the C-TDMA S2 case, the gaming RTT P95 latency was about 15 ms. For the C-TDMA S3 case, the gaming RTT P95 latency was about 30 ms. For the C-TDMA S4 case, the gaming RTT P95 latency was about 23 ms.

For BSS3, for the uncoordinated case, the gaming RTT P95 latency was about 38 ms. For the C-TDMA S1 case, the gaming RTT P95 latency was about 36 ms. For the C-TDMA S2 case, the gaming RTT P95 latency was about 30 ms. For the C-TDMA S3 case, the gaming RTT P95 latency was about 32 ms. For the C-TDMA S4 case, the gaming RTT P95 latency was about 32 ms.

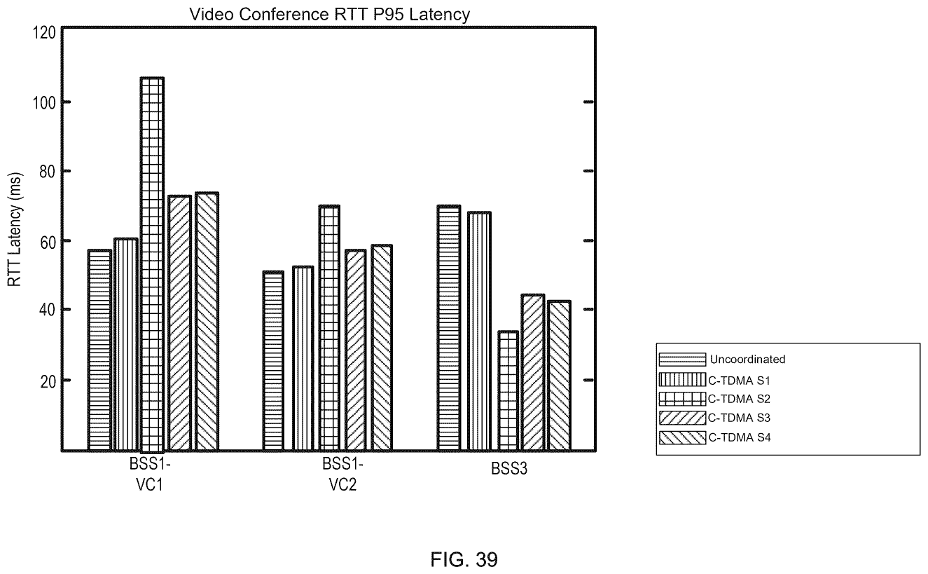

As illustrated in FIG. 39, BSS2 had no VI AC traffic; therefore there was no effective cooperation between the APs, resulting in a performance degradation. In the case of having cooperation between BSS1 and BSS3, instead of BSS2, the results may be different, similar to the results found in Scenario 1.

For BSS1-VC1, for the uncoordinated case, the video conference RTT P95 latency was about 58 ms. For the C-TDMA S1 case, the video conference RTT P95 latency was about 60 ms. For the C-TDMA S2 case, the video conference RTT P95 latency was about 110 ms. For the C-TDMA S3 case, the video conference RTT P95 latency was about 70 ms. For the C-TDMA S4 case, the video conference RTT P95 latency was about 70 ms.

For BSS1-VC2, for the uncoordinated case, the video conference RTT P95 latency was about 50 ms. For the C-TDMA S1 case, the video conference RTT P95 latency was about 52 ms. For the C-TDMA S2 case, the video conference RTT P95 latency was about 70 ms. For the C-TDMA S3 case, the video conference RTT P95 latency was about 60 ms. For the C-TDMA S4 case, the video conference RTT P95 latency was about 62 ms.

For BSS3, for the uncoordinated case, the video conference RTT P95 latency was about 70 ms. For the C-TDMA S1 case, the video conference RTT P95 latency was about 68 ms. For the C-TDMA S2 case, the video conference RTT P95 latency was about 28 ms. For the C-TDMA S3 case, the video conference RTT P95 latency was about 32 ms. For the C-TDMA S4 case, the video conference RTT P95 latency was about 32 ms.

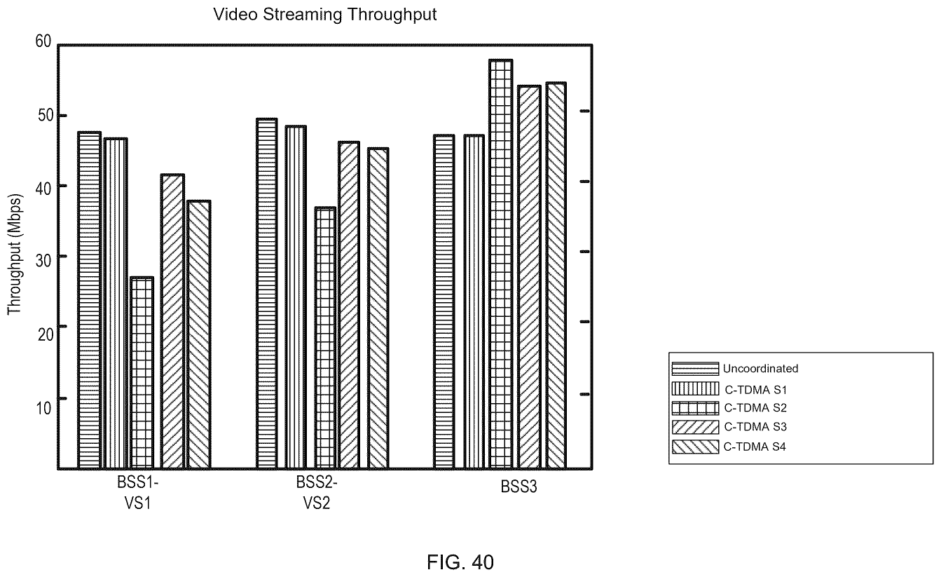

As illustrated in FIG. 40, BSS2 had no VI AC traffic, therefore there was no effective cooperation between the APs, resulting in a performance degradation. In the case of having cooperation between BSS1 and BSS3, instead of BSS2, the results may be different, (similar to the ones found in Scenario 1).

For BSS1-VS1, for the uncoordinated case, the video streaming throughput was about 48 Mbps. For the C-TDMA S1 case, the video streaming throughput was about 47 Mbps. For the C-TDMA S2 case, the video streaming throughput was about 27 Mbps. For the C-TDMA S3 case, the video streaming throughput was about 42 Mbps. For the C-TDMA S4 case, the video streaming throughput was about 40 Mbps.

For BSS1-VS2, for the uncoordinated case, the video streaming throughput was about 50 Mbps. For the C-TDMA S1 case, the video streaming throughput was about 48 Mbps. For the C-TDMA S2 case, the video streaming throughput was about 37 Mbps. For the C-TDMA S3 case, the video streaming throughput was about 47 Mbps. For the C-TDMA S4 case, the video streaming throughput was about 47 Mbps.

For BSS3, for the uncoordinated case, the video streaming throughput was about 48 Mbps. For the C-TDMA S1 case, the video streaming throughput was about 48 Mbps. For the C-TDMA S2 case, the video streaming throughput was about 58 Mbps. For the C-TDMA S3 case, the video streaming throughput was about 55 Mbps. For the C-TDMA S4 case, the video streaming throughput was about 56 Mbps.

### Example 2C: Summary

The network topology and traffic setup are parameters that define the suitability of cooperation between two APs. The wrong choice can deteriorate the performance of both networks. The C-TDMA coordination was effective in the case that both APs generated an equal number of channel gain opportunities in the same AC (priority). For Repeater/Mesh and balanced OBSS scenarios, we obtained similar performance for the case where the C-TDMA threshold was set from higher layers (managed) and the case where the threshold was dynamically calculated and negotiated between the AP. C-TDMA mechanism may be enabled per AC, instead of using for all the traffic, especially for those high-priority services, being used in both networks.

Some portions of the detailed description refer to different modules configured to perform operations. One or more of the modules may include code and routines configured to enable a computing system to perform one or more of the operations described therewith. Additionally or alternatively, one or more of the modules may be implemented using hardware including any number of processors, microprocessors (e.g., to perform or control performance of one or more operations), DSPs, FPGAs, ASICs or any suitable combination of two or more thereof. Alternatively or additionally, one or more of the modules may be implemented using a combination of hardware and software. In the present disclosure, operations described as being performed by a particular module may include operations that the particular module may direct a corresponding system (e.g., a corresponding computing system) to perform. Further, the delineating between the different modules is to facilitate explanation of concepts described in the present disclosure and is not limiting. Further, one or more of the modules may be configured to perform more, fewer, and/or different operations than those described such that the modules may be combined or delineated differently than as described.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of configured operations leading to a desired end state or result. In example implementations, the operations carried out require physical manipulations of tangible quantities for achieving a tangible result.

Unless specifically stated otherwise, as apparent from the discussion, it is appreciated that throughout the description, discussions utilizing terms such as detecting, determining, analyzing, identifying, scanning or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. Computer-executable instructions may include, for example, instructions and data which cause a general-purpose computer, special-purpose computer, or special-purpose processing device (e.g., one or more processors) to perform or control performance of a certain function or group of functions.

Although the subject matter has been described in language specific to structural features and/or methodological acts, it is to be understood that the subject matter configured in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined in whole or in part to enhance system functionality and/or to produce complementary functions. Likewise, aspects of the implementations may be implemented in standalone arrangements. Thus, the above description has been given by way of example only and modification in detail may be made within the scope of the present disclosure.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements.

The present disclosure may be embodied in other specific forms without departing from its spirit or essential characteristics. The described implementations are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An access point (AP), comprising:
a processing device operable to:
determine, at the access point, an assigned time for the access point and a wireless device;
receive, at the access point, a transmission opportunity (TXOP);
identify, at the access point, scheduling information for the TXOP, wherein the TXOP is partitioned into a plurality of TXOP partitions comprising first TXOP partitions associated with the access point and second TXOP partitions associated with the wireless device; and
provide, from the access point to the wireless device, scheduling information for the TXOP.

2. The access point of claim 1, wherein the processing device is further operable to provide scheduling information for the TXOP using triggered TXOP sharing.

3. The access point of claim 1, wherein the processing device is further operable to:
synchronize the timing for the access point and the wireless device using one or more of:
a trigger frame from the access point as an initial time reference, or
a synchronized internal timer for access point and a synchronized internal timer for the wireless device.

4. The access point of claim 1, wherein the processing device is further operable to synchronize the timing for the access point and the wireless device using TSF from a repeater in communication with the access point and the wireless device.

5. The access point of claim 1, wherein the wireless device is one or more of a repeater, an additional access point, or a station (STA).

6. The access point of claim 1, wherein the processing device is further operable to facilitate an end-to-end quality of service guarantee in a plurality of network segments.

7. The access point of claim 1, wherein the TXOP is further partitioned into n TXOP partitions associated with n additional wireless devices.

8. The access point of claim 7, wherein the n additional wireless devices comprises one or more of: one or more repeaters, one or more access points, or one or more STAs.

9. A method for maintaining a latency between a first network segment and a second network segment, comprising:
synchronizing a timing for an access point and a first wireless device;
determining transmission opportunity (TXOP) scheduling for the access point and the first wireless device;
transmitting data from the access point to the first wireless device; and
transmitting the data from the first wireless device to a second wireless device.

10. The method of claim 9, further comprising:
synchronizing the timing for the access point and the first wireless device using one or more of:
a trigger frame from the access point as an initial time reference, or
a synchronized internal timer for access point and a synchronized internal timer for the first wireless device.

11. The method of claim 9, further comprising:
synchronizing the timing for the access point and the first wireless device using TSF from the first wireless device in communication with the access point and the second wireless device.

12. The method of claim 9, further comprising:
determining TXOP scheduling by partitioning the TXOP into a plurality of TXOP partitions comprising first TXOP partitions associated with the access point and second TXOP partitions associated with the first wireless device.

13. The method of claim 9, further comprising:
determining TXOP scheduling by partitioning the TXOP into n sets of TXOP partitions, wherein the n sets of TXOP partitions is associated with n additional wireless devices.

14. The method of claim 9, wherein the first wireless device is a repeater.

15. The method of claim 9, further comprising:
facilitating an end-to-end quality of service guarantee in a plurality of network segments.

16. A repeater, comprising:
a processing device operable to:
synchronize, at the repeater, a timing for the repeater and an access point;
receive, at the access point, scheduling information for a transmit opportunity (TXOP);
receive, at the repeater, data from the access point; and
transmit, from the repeater to a station (STA), the data.

17. The repeater of claim 16, wherein the processing device is further operable to:
receive, at the repeater from the STA, additional data; and
transmit, from the repeater to the access point, the additional data.

18. The repeater of claim 16, wherein the processing device is further operable to:
synchronize, at the repeater, a timing for the repeater and an access point using TSF.

19. The repeater of claim 16, wherein the processing device is further operable to:
synchronize, at the repeater, a timing for one or more additional wireless devices.

20. The repeater of claim 16, wherein the processing device is further operable to:
facilitating an end-to-end quality of service guarantee in a plurality of network segments.
